(19) United States
(12) Patent Application Publication
(10) Pub. No.: US 2021/0056467 A1
(43) Pub. Date: Feb. 25, 2021

(54) TRAINING MACHINE LEARNING MODELS FOR INTEREST PREDICTION

(71) Applicant: KEFI Holdings, Inc., Atlanta, GA (US)

(72) Inventors: ANDREAS PANAYIOTOU, Atlanta, GA (US); Nathan McFarland, Atlanta, GA (US)

(21) Appl. No.: 16/998,595

(22) Filed: Aug. 20, 2020

Related U.S. Application Data
(60) Provisional application No. 62/889,355, filed on Aug. 20, 2019.

(51) Int. Cl. G06N 20/00; G06K 7/10

(52) U.S. Cl. CPC G06N 20/00; G06K 7/10366

(57) ABSTRACT

A process for training a computer-implemented model can comprise collecting, via at least one computing device, training data associated with at least one entity. The training data can comprise categorical data, observational data, and at least one known interest. A training dataset can be generated based on the categorical data, wherein the training dataset comprises the known interest and a plurality of parameters based on the categorical data. A respective weight can be determined for each of the plurality of parameters based on the observational data. A weight can be generated for each of the plurality of parameters based on the respective weight value corresponding to each of the plurality of parameters. A machine learning model for predicting interests can be generated and trained using the training dataset.

### CROSS-REFERENCE TO RELATED APPLICATIONS

This application claims the benefit of and priority to U.S. Patent Application No. 62/889,355, filed Aug. 20, 2019, entitled “SYSTEMS AND METHODS FOR GENERATING A RECOMMENDATION,” which is incorporated herein by reference in its entirety.

### TECHNICAL FIELD

The present systems and methods relate generally to tracking behavior of a subject and generating behavior analyses and recommendations based on tracked behavior.

### BACKGROUND

The determination of a subject's interests can be valuable for various purposes, such as identifying activities and locations that are best suited for a subject or supporting the subject's cognitive development. For example, parents may seek to better understand their child's interests, because, by doing so, those interests may be better supported and nurtured. Previous systems for determining a child's interests may rely largely upon anecdotal observations and inferences and, thus, may not provide a degree of analytical complexity necessary to accurately evaluate child behavior and determine interests. Children may express their interests through play activities that can include particular toys, books, activities, and locations (whether physical, virtual, or imagined). Previous solutions to determining child interests and providing recommendations may not take into account a wide spectrum of information that can be obtained by tracking child behavior throughout a play environment. Moreover, previous solutions may be limited by the amount of attention that an observer is able to pay to each individual child when groups are playing, and finding skilled and trained observers to observe play behavior for each child may be costly. Therefore, there is a long-felt but unresolved need for a system or method that allows for a prediction of interests based on tracked and observed behaviors.

### BRIEF SUMMARY OF THE DISCLOSURE

Briefly described, and according to one embodiment, aspects of the present disclosure generally relate to systems and processes for tracking subject behavior in physical and digital environments and for predicting interests of the subject based on tracked behavior.

For the purposes of explanation and illustration, various embodiments of the present systems and methods are described herein in the context of tracking child behavior in a play environment. However, this disclosure places no limitations on the type of subject or environment that may be monitored and for which various predictions may be generated. At a high level, the present technology relates to using interaction data associated with a subject in an interactive environment to produce a profile of elements that describe the behavior of the subject and provides recommendations of other elements (e.g., environments, activities, objects) the subject may enjoy. Provided herein are systems and methods for tracking and recording play behavior of a subject in a particular environment, evaluating tracked and recorded subject play behavior to determine subject interests and subject growth and development, generating one or more recommendations based on determined subjects interests, and providing the one or more recommendations to the subject and/or an affiliate thereof. In one or more embodiments, the present system can collect a variety of data associated with a child interacting with display screens, physical objects (e.g., toys), or electronic devices in an interactive environment. The system can analyze the collected data to identify movement patterns, toy preferences and other behavior trends. In various embodiments, the system generates an electronic report including a summary of the child's interactions, favored toys, etc., in addition to one or more recommendations describing additional environments, activities, toys, etc. that the child may enjoy.

The system can track the behavior of an individual, evaluate and analyze the tracked behavior, identify subject matter that an individual enjoys (for example, playing with a toy train) and generate a report describing the tracked behavior and providing recommendations for additional subject matter (e.g., activities, environments, items, etc.) the subject may enjoy (e.g., based on the originally identified subject matter). Accordingly, the present system can receive electronic input from a variety of data sources dispersed throughout an environment. The data sources can provide information on environment interaction including, but not limited to, entry into/exit from a particular area, interactions with objects, screens, electronic devices and other elements provided in an environment, interaction with another subject, and other behaviors and activities (that may occur in a physical or digital environment). The system may also collect (e.g., from a database) historical interaction or other data associated with one or more subjects.

After obtaining data associated with a particular subject, the system can automatically generate an electronic report. The electronic report can summarize behavior and activities of the subject (for example, what they played with, what areas they played in, whether they played alone, etc.) and provide one or more recommendations for additional subject matter (e.g., toys, activities, etc.) in which the subject may find interest. The electronic report may also include metrics, computed by the system, that describe subject behavior and, in some embodiments, compare aspects of the subject's behavior to “averaged” (e.g., typical) interaction data. The electronic report can provide insights into a child's play behavior and demeanor, in particular, as related to child development and child psychology. The insights can be provided, individually or in combination, as metrics, as visualizations, or as text-based descriptions. The system can provide the electronic report to the subject, or a guardian or representative thereof, by generating and transmitting an electronic communication and/or by providing the electronic report on a website, or another similar medium. The system can embed trackable content in the electronic communication and/or website to assess engagement with the electronic communication, and better inform subsequent communication generation processes.

According to a first aspect, a process for training a computer-implemented model, comprising: A) collecting, via at least one computing device, training data associated with at least one entity, wherein the training data comprises categorical data, observational data, and at least one known interest; B) generating, via the at least one computing device, a training dataset based on the categorical data, wherein the training dataset comprises the known interest and a plurality of parameters based on the categorical data; C) determining, via the at least one computing device, a respective weight value for each of the plurality of parameters based on the observational data; D) generating, via the at least one computing device, a respective weight for each of the plurality of parameters based on the respective weight value corresponding to each of the plurality of parameters; and E) training, via the at least one computing device, a machine learning model using the training dataset.

According to a further aspect, the process of the first aspect or any other aspect, wherein the categorical data comprises cognitive development markers.

According to a further aspect, the process of the first aspect or any other aspect, wherein a first subset of the training data is collected from a physical environment and a second subset of the training data is collected from a digital environment, wherein the digital environment comprises an electronic communication.

According to a further aspect, the process of the first aspect or any other aspect, further comprising executing, via the at least one computing device, the machine learning model to generate an output comprising an interest associated with an additional entity.

According to a further aspect, the process of the first aspect or any other aspect, further comprising: A) generating, via the at least one computing device, an alert comprising the output, a networking address associated with the output, and an activity associated with the interest; and B) causing, via the at least one computing device, the alert to be rendered on at least one computing device associated with the additional entity.

According to a further aspect, the process of the first aspect or any other aspect, further comprising: A) collecting, via the at least one computing device, secondary data associated with the additional entity, the secondary data comprising secondary categorical data and secondary observational data; B) adjusting, via the at least one computing device, each of the plurality of parameters based on the secondary categorical data; and C) adjusting, via the at least one computing device, the respective weight value of each the plurality of parameters based on the secondary observational data.

According to a further aspect, the process of the first aspect or any other aspect, wherein the machine learning model is a neural network.

According to a second aspect, a system for training a computer-implemented model, comprising: A) a data store configured to store training data comprising categorical data, observational data, and at least one known interest; B) at least one computing device in communication with the data store, the at least one computing device being configured to: 1) collect training data associated with at least one entity; 2) generate a training dataset based on the categorical data, the training dataset comprising the known interest and a plurality of parameters based on the categorical data; 3) determine a respective weight value for each of the plurality of parameters based on the observational data; 4) generate a respective weight for each of the plurality of parameters based on the respective weight value corresponding to each of the plurality of parameters; and 5) train a machine learning model using the training dataset.

According to a further aspect, the system of the second aspect or any other aspect, wherein the categorical data comprises cognitive development markers.

According to a further aspect, the system of the second aspect or any other aspect, wherein a first subset of the training data is collected from a physical environment and a second subset of the training data is collected from a digital environment, wherein the digital environment comprises an electronic communication.

According to a further aspect, the system of the second aspect or any other aspect, wherein the at least one computing device is further configured to execute the machine learning model to generate an output comprising an interest associated with an additional entity.

According to a further aspect, the system of the second aspect or any other aspect, wherein the at least one computing device is further configured to: A) generate an alert comprising the output, a networking address associated with the output, and an activity associated with the interest; and B) cause the alert to be rendered on a computing device associated with the entity.

According to a further aspect, the system of the second aspect or any other aspect, wherein the at least one computing device is further configured to: A) collect secondary data associated with the additional entity, the secondary data comprising secondary categorical data and secondary observational data; B) adjust each of the plurality of parameters based on the secondary categorical data; and C) adjust the respective weight value of each the plurality of parameters based on the secondary observational data.

According to a further aspect, the system of the second aspect or any other aspect, wherein the training data further comprises digital interaction data and a subset of the training dataset is based on the digital interaction data.

According to a third aspect, a non-transitory computer-readable medium for training a computer-implemented model having stored thereon computer program code that, when executed on at least one computing device, causes the at least one computing device to: A) collect training data associated with at least one entity, the training data comprises categorical data, observational data, and at least one known interest; B) generate a training dataset based on the categorical data, the training dataset comprising the known interest and a plurality of parameters based on the categorical data; C) determine a respective weight value for each of the plurality of parameters based on the observational data; D) generate a respective weight for each of the plurality of parameters based on the respective weight value corresponding to each of the plurality of parameters; and E) train a machine learning model using the training dataset.

According to a further aspect, the non-transitory computer-readable medium of the third aspect or any other aspect, wherein the categorical data comprises cognitive development markers.

According to a further aspect, the non-transitory computer-readable medium of the third aspect or any other aspect, wherein a first subset of the training data is collected from an RFID-based source and a second subset of the training data is collected from a computer vision-based source.

According to a further aspect, the non-transitory computer-readable medium of the third aspect or any other aspect, wherein the computer program code further causes the at least one computing device to execute the machine learning model to generate an output comprising: A) a most-weighted parameter of the plurality of parameters; and B) an interest associated with an additional entity and the most-weighted parameter of the plurality of parameters.

According to a further aspect, the non-transitory computer-readable medium of the third aspect or any other aspect, wherein the computer program code further causes the at least one computing device to: A) generate an alert comprising the output, a networking address associated with the output, and a location associated with the interest; and B) cause the alert to be rendered on a computing device associated with the entity.

According to a further aspect, the non-transitory computer-readable medium of the third aspect or any other aspect, wherein the computer program code further causes the at least one computing device to generate a cognitive development summary of the entity based on the plurality of parameters and the output, wherein the alert further comprises the cognitive development summary.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1A illustrates an exemplary system architecture, according to one embodiment of the present disclosure.

FIG. 1B illustrates an exemplary networked computing environment, according to one embodiment of the present disclosure.

FIG. 2 illustrates an exemplary operational computing architecture, according to one embodiment of the present disclosure.

FIG. 3 illustrates an exemplary aggregated computing architecture, according to one embodiment of the present disclosure.

FIG. 4 illustrates an exemplary recommendation engine architecture, according to one embodiment of the present disclosure.

FIG. 5 illustrates an exemplary communication module architecture, according to one embodiment of the present disclosure.

FIG. 6 is a flowchart of an exemplary data aggregation process, according to one embodiment of the present disclosure.

FIG. 7 is a flowchart of an exemplary data collection and recommendation generation process, according to one embodiment of the present disclosure.

FIG. 8 is a flowchart of an exemplary machine learning process, according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context indicates that such limitation is intended.

### Overview

Aspects of the present disclosure generally relate to tracking behavior of a subject and generating behavior analyses and recommendations based on tracked behavior.

In at least one embodiment, the present disclosure provides systems and methods for monitoring and evaluating behavior from one or more subjects in a particular environment, and, based on behavior evaluations, generating a recommendation for experiences, items, and activities the one or more subjects may enjoy. For illustrative purposes, the present systems and methods are described in the context of an interactive play area for children.

The present system can include a variety of interaction and engagement techniques that collect information on a subject's (e.g., a child's) play behavior in one or more particular regions of a play area. The system can utilize data collection techniques including, but not limited to, radio frequency identification (“RFID”) tracking, computer vision, analysis of subject-generated content, free form inputs (e.g., received by the system from one or more individuals), and online interaction tracking (e.g., via read receipts, cookies, links, etc.). The system may receive data from a variety of sources (e.g., RFID tags, one or more processors, a website, etc.).

The system includes at least one physical environment in which a subject interacts with a variety of items (e.g., toys), persons and experiences (e.g., pre-engineered events that occur in response to a specific trigger). In one or more embodiments, the subject may carry and/or wear an RFID tag (for example, in the form of an RFID wristband) that is responsive to interrogations from a plurality of RFID devices (e.g., RFID tags, antennae, etc.) that are located throughout the at least one physical environment. Thus, the one or more physical environment may contain a plurality of electronic devices (referred to as “RFID sources”) that can interrogate and communicate with the RFID wristband. In various embodiments, an RFID source may be responsive to the RFID wristband (and/or other RFID tags not borne by the subject) in one or more scenarios including, but not limited to, the subject (wearing the RFID wristband) moving within a predefined proximity of an RFID source, the subject moving an RFID tag-containing item within a predefined proximity of an RFID source, and the subject moving within a predefined proximity of another subject (e.g., that is also wearing an RFID wristband, or the like).

In various embodiments, an RFID tag of the present system (e.g., whether disposed in a wristband, or otherwise) may include a unique RFID identifier that can be associated with a bearer of the RFID tag (e.g., a subject, object, location, etc.). Thus, an RFID tag borne by a subject (e.g., wearing an RFID wristband) may include a unique RFID identifier that associates the subject with the RFID tag. The RFID tag may also include the unique RFID identifier in any and all transmissions occurring from the RFID tag to one or more RFID sources. Thus, the system, via the one or more RFID sources, can receive data (from an RFID tag) that is uniquely associated with a subject. Accordingly, the system can collect data regarding a subject's play behavior and location as the subject proceeds through a particular environment. In at least one embodiment, the system may collect data (via RFID interactions) pertaining to a location of a subject within a particular environment, a proximity of a first subject to a second subject, interaction of a subject with an item, an interaction of a subject with an environmental feature (as described herein and henceforth referred to as an “experience”), and any combination of subject location, interaction and proximity to another subject. Using RFID interaction data and other data described herein, the system can collect and analyze data to generate insights into a subject's behavioral trends in the particular environment (with respect to locations, objects, experiences, and other subjects therein). The system can perform one or more algorithmic methods, machine learning methods and pattern recognition methods to evaluate a subject's behavioral trends, predict one or more interests of the subject and generate one or more recommendations for events, activities, items and/or resources with which the subject may find interest. The system can be configured to generate an electronic communication that includes the one or more recommendations (e.g., as well as evaluations of behavioral trends) and transmit the electronic communication to the subject, or a representative or guardian thereof.

The following paragraphs provide an exemplary scenario of play behavior monitoring and analysis, and recommendation generation. The following scenario occurs within the context of a play environment (as described herein).

In an exemplary scenario, a child enters the play environment. Upon entering, the child receives an RFID wristband that is worn throughout his/her time in the play environment. The RFID wristband includes an identifier that is associated with a user identifier, the user identifier being associated with the child. The child enters a train area, and, as the child enters the train area, an RFID source interrogates the RFID wristband and a computer vision source identifies a toy train with which the child has begun to play. A projection source displays, on the floor of the train area, a forest. The computer vision source identifies that the child has picked up toy railroad pieces, and a staff member inputs data into an electronic tablet noting the creative and curious play behavior. The computer vision source tracks placement of the toy railroad and determines that the child has avoided building through the projected forest, and the staff member inputs an observation that the child is environmentally conscious of the forest.

As the child plays, a second child enters the train area (which is recorded by the RFID source). The computer vision source tracks the proximity of the first child to the second child, and the staff member inputs data indicating that the children are playing together. The second child places a toy boat onto the railroad tracks, which is detected by the computer vision source, the staff member, an RFID source (e.g., an RFID source disposed within the floor that interrogates an RFID tag disposed within the boat). The first child removes the toy boat from the railroad and explains to the second child that the boat belongs in water. The computer vision source, the staff member, and the RFID source detect a removal of the boat, and the staff member inputs data indicating the first child exercised category formation skills and conversed with the second child (to explain categories of vehicles). The computer vision source and the staff member continue tracking play behavior of the first and second child, as the children continue working together to complete the toy railroad. After some time, the first child leaves the train area, and, while exiting the train area, an RFID source interrogates the first child's wristband. The first child returns their wristband and exits the play environment.

Following return of the wristband, the system determines that the first child has exited the play environment, and initiates a recommendation generation process. The system retrieves aggregated data from the child's most recent visit, and also retrieves, as described herein, historical aggregated data, web interaction data, recommendation data, survey data, and engagement data. The system performs machine learning and artificial intelligence (AI) techniques to analyze the retrieved data. By the machine learning and AI techniques, the system predicts the interests of the child. Based on the child's avoidance of the forest while building the toy railroad, the system predicts that the child enjoys and/or is disposed to outdoor activities and natural landscapes (in particular, forests). Based on the child's play in the train area, the system also predicts that the child is interested in trains and transportation.

The system also leverages the machine learning and AI techniques to formulate determinations regarding the child's growth and development. In one example, via machine learning and/or other AI techniques, the system determines that the child demonstrated proficiency in attention span because computer vision and RFID data indicate that the child played in the toy area with train toys for a significant portion of their visit. In another example, the system determines that the child demonstrated proficient creativity because inputted data and computer vision data indicate that the child built a toy railroad. In another example, the system determines that the child demonstrated self-awareness, self-management, and social awareness because the input, RFID, and computer vision data indicate that the child played cooperatively with another child in the toy area and tolerated modification, by the other child, of their toy railroad. In another example, the system determines that the child demonstrated fine motor skills because the inputted, computer vision, and RFID data indicate that the child successfully configured pieces of the toy railroad. In another example, the system determines that the child demonstrated category formation because the inputted, computer vision, and RFID data indicate that the child removed a toy boat placed on the toy railroad. In another example, the system determines that the child demonstrated speaking and listening skills because the inputted data indicate that the child conversed with another child.

The system provides the identified interests (forests, trains, outdoor activities, etc.) and growth and development determinations to a recommendation engine. The recommendation engine processes the provided elements and generates recommendations. The recommendations include suggestions for a cooperative train building board game, a children's book on benefits of forests, and an upcoming children's activity day occurring at a nearby state park. The system provides, to a communication engine, information including the recommendations, the predicted interests, and the generated determinations. The communication engine processes the information and generates an electronic report. The electronic report can summarize the child's play behavior during their most recent play environment visit and can include, for example, pie charts providing a visualization of time spent in each area of the play environment, time spent socializing, and time spent with one or more toys. In another example, the electronic report includes text-based descriptions of growth and development demonstrated by the child (as indicated in the generated determinations). In another example, the electronic report includes recommendations, such as text-based descriptions of predicted interests and/or determinations that resulted in the system generating the recommendations.

The communication engine provides the electronic report, to a parent of the child, via an electronic communication. The communication engine also embeds trackable content in the electronic communication, and an engagement tracker collects engagement data regarding interactions of the parent with the electronic communication (e.g., links clicked, time metrics, etc.). The system stores the engagement data, which may be processed by the communication engine in subsequent communication generation activities to augment and tailor subsequently generated electronic communications such that engagement (with the communication and reports therein) is increased.

### Exemplary Embodiments

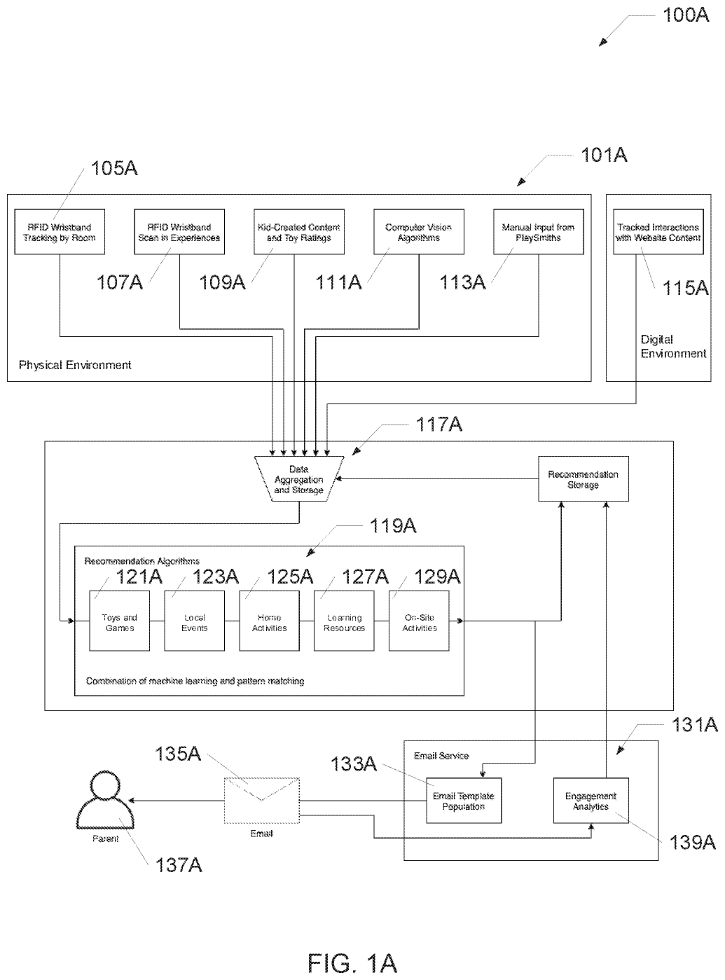

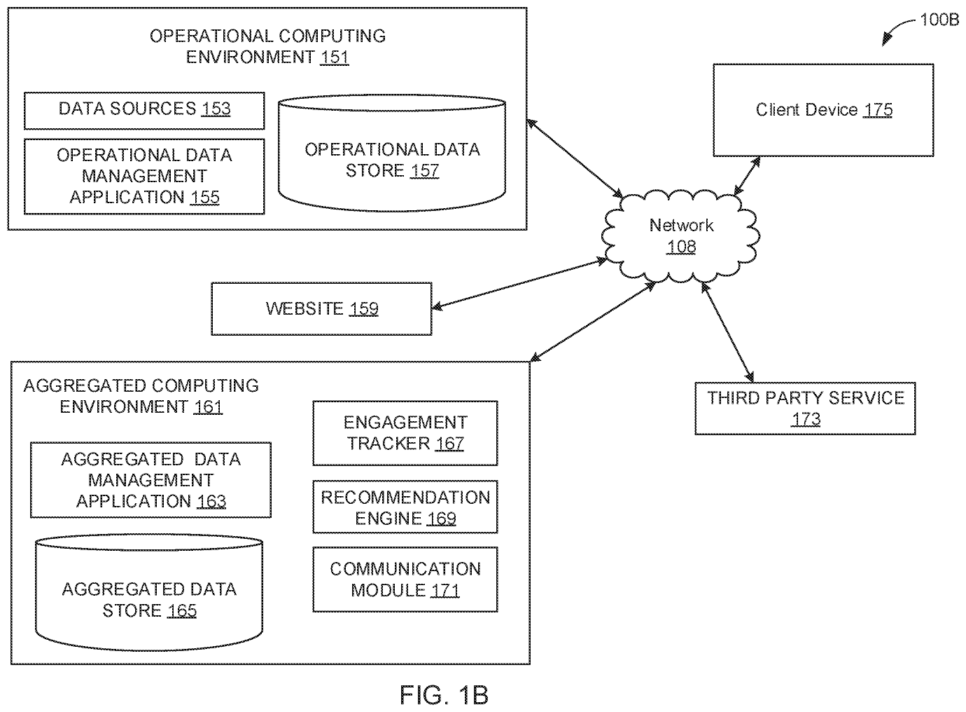

Referring now to the figures, for the purposes of example and explanation of the fundamental processes and components of the disclosed systems and processes, reference is made to FIG. 1A, which illustrates architecture of a system 100A. As will be understood and appreciated, the system 100A shown in FIG. 1A represents merely one approach or embodiment of the present system, and other aspects are used according to various embodiments of the present system.

With reference to FIG. 1A, shown is a system 100A. The system 100A can be implemented in a play environment where subjects (e.g., children) interact with system elements including, but not limited to, locations (e.g., particular rooms and areas), display screens, physical objects (e.g., toys), or electronic devices to engage in play behavior. The system 100A can detect and record interactions with the system elements (e.g., play behavior data) by a variety of data collection systems 101A including, but not limited to, RFID wristband location tracking 105A, RFID wristband experience tracking 107A, subject content tracking 109A, computer vision sources 111A, manual inputs 113A (e.g., inputted data from staff members present in the play environment), and website engagement tracking 115A. The system 100A can aggregate and store the recorded play behavior data, from the data collection systems 101A, at one or more databases 117A. The system 100A can provide the stored play behavior data to a recommendation engine 119A that applies one or more recommendation algorithms (e.g., as part of a machine learning and/or artificial intelligence process) to predict subject interests, formulate one or more determinations regarding growth and development of the subject, and generate one or more recommendations (e.g., based on the predicted subject interests and determinations). The one or more recommendations can include, but are not limited to, recommendations for, toys and games 121A, local events 123A, offsite activities 125A, resources 127A, and on-site activities 129A. The system can store the one or more recommendations in the one or more databases 117A.

In an exemplary scenario, a child enters a play environment and receives an RFID wristband (as described herein). The system, via computer vision sources 111A and RFID wristband location tracking 105A, detects movement of the child into a music-themed room. Upon entering the music-themed room, the child plays with an oversized music generator. The system, via RFID wristband experience tracking 107A, detects that the child is playing with the music generator. As the child is playing, a second child approaches and asks for a turn at the music generator, and the child discusses turn times with the second child, and agrees to give the second child a turn shortly. A staff member observes the conversation, negotiation, and compromise between the children and records the observations on an electronic tablet, which converts the observations into manual inputs 113A. At the conclusion of their turn, the child executes a “save” function on the music generator, thereby storing a melody that the child composed. The system 100A, in response to detecting the “save,” stores the melody, thereby performing subject content tracking 109A. After his/her turn, the child exits the music-themed room, returns his/her wristband, and departs from the play environment. The system, via RFID wristband location tracking 105A, detects the exit of the child from the play environment. Throughout the child's time in the play environment, the system stores and aggregates the collected play behavior data in one or more databases 117A.

Upon detecting that the child has exited the play environment, the system initiates a recommendation generation process. A recommendation engine 119A retrieves the child's play behavior data and executes one or more recommendation generation processes. Based on analyses of the play behavior data, the recommendation engine 119A identifies that the child entered the music-themed room, played with the music generator, and saved his/her melody, and the recommendation engine 119A predicts that the child is interested in music and musical instruments. The recommendation engine 119A also identifies that the child engaged in a constructive conversation with the second child, and, accordingly, the recommendation engine determines that the child demonstrated positive growth and development. In one example, the recommendation engine 119A determines that the child demonstrated problem-solving. The determination may be because the child negotiated a compromise between themselves and the second child. In the same example, the recommendation engine 119A determines that the child demonstrated self-awareness, self-management, and social awareness, which may be because the child recognized that the second child had an inherent right to play with the music generator. Continuing this example, the recommendation engine 119A determines that the child demonstrated relationship skills, which may be because the child engaged in a positive social interaction. In the same example, the recommendation engine 119A determines that the child demonstrated speaking and listening skills, which may be because the child listened to and considered the input of the second child, and delivered a thoughtful response to the second child.

Based on the predicted interests and determinations, the recommendation engine 119A can generate recommendations for a local children's music event (e.g., a local event 123A), an introductory book on musical composition (e.g., a resource 127A), and a guest musical performance occurring next week in the music-themed room (e.g., an on-site activity 129A). The system can provide the one or more recommendations, predicted interests, and growth and development determinations to a communication engine 131A (e.g., an email service, or another communication generator). The communication engine 131A can populate a template 133A to include the one or more recommendations, predicted interests, and determinations, and other content, thereby generating an electronic communication 135A. The system can transmit the electronic communication 135A to a user 137A, which may be the subject and/or a guardian thereof (e.g., a parent). The communication engine 131A can also embed, into the electronic communication 135A, trackable content. The system can record and process interactions with the trackable content (e.g., clicks, etc.) to generate engagement analytics 139A that can be used to optimize processes of the recommendation engine 119A and the communication engine 131A (e.g., to improve recommendations and increase engagement with subsequent electronic communications 135A).

With reference to FIG. 1B, shown is a system 100B according to various embodiments. In various embodiments, the system 100B is substantially similar to the system 100A. The system 100B may include an operational computing environment 151, an aggregated computing environment 161, one or more third-party service 173 and one or more client devices 175, all of which are in data communication with each other via at least one network 108. The network 108 includes, for example, the Internet, intranets, extranets, wide area networks (WANs), local area networks (LANs), wired networks, wireless networks, or other suitable networks, etc., or any combination of two or more such networks. For example, such networks may include satellite networks, cable networks, Ethernet networks, and other types of networks.

The operational environment 151 and the aggregated environment 161 may include, for example, a server computer or any other system providing computing capability. Alternatively, the operational environment 151 and the aggregated environment 161 may employ computing devices that may be arranged, for example, in one or more server banks or computer banks or other arrangements. Such computing devices may be located in a single installation or may be distributed among many different geographical locations. For example, the operational environment 151 and the aggregated environment 161 may include computing devices that together may include a hosted computing resource, a grid computing resource and/or any other distributed computing arrangement. In some cases, the operational environment 151 and the aggregated environment 161 may correspond to an elastic computing resource where the allotted capacity of processing, network, storage, or other computing-related resources may vary over time. In some embodiments, the operational environment 151 and the aggregated environment 161 may be executed in the same computing environment.

Various applications and/or other functionality may be executed in the operational environment 151 according to various embodiments. The operational environment 151 may include and/or be in communication with data sources 153. The operational environment 151 can include an operational data management application 155 that can receive and process data from the data sources 153. The operational data management application 155 can include one or more processors and/or servers, and, and can be connected to an operational data store 157. The operational data store 157 may organize and store data, sourced from the data sources 153, that is processed and provided by the operational data management application 155. Accordingly, the operational data store 157 may include one or more databases, or other storage mediums for maintaining a variety of data types. The operational data store 157 may be representative of a plurality of data stores, as can be appreciated. Also, data stored in the operational data store 157, for example, can be associated with the operation of various applications and/or functional entities described herein. Data stored in the operational data store 157 may be accessible to the operational environment 151 and to the aggregated computing environment 161. The aggregated computing environment 161 can access the operational data store 157 via the network 108.

The aggregated environment 161 may include an aggregated data management application 163. The aggregated data management application 163 may receive and process data from the operational environment 151, from the web site 159, from the third party service 173, and from the client device 175. The aggregated data management application 163 may receive data uploads from the operational computing environment 151, such as, for example, from the operational data management application 155 and operational data store 157. In at least one embodiment, data uploads between the operational computing environment 151 and aggregated computing environment 161 may occur manually and/or automatically, and may occur at a predetermined frequency (for example, daily) and capacity (for example, a day's worth of data). As an example, a user may manually initiate an upload or the upload may be automatically performed according to a schedule or trigger by software or hardware.

The aggregated environment 161 may further include an aggregated data store 165. The aggregated data store 165 may organize and store data that is processed and provided by the aggregated data management application 163. Accordingly, the aggregated data store 165 may include one or more databases, or other storage mediums for maintaining a variety of data types. The aggregated data store 165 may be representative of a plurality of data stores, as can be appreciated. In at least one embodiment, the aggregated data store 165 can be at least one distributed database (for example, at least one cloud database). Also, data stored in the aggregated data store 165, for example, can be associated with the operation of various applications and/or functional entities described herein. In at least one embodiment, the operational data store 157 and the aggregated data store 165 may be a shared data store (e.g., that may be representative of a plurality of data stores).

The operational data store 157 may provide or send data therein to the aggregated computing environment 161. Data provided by the operational data store 157 can be received at and processed by the aggregated data management application 163 and, upon processing, can be provided to the aggregated data store 165 (e.g., for organization and storage). In one embodiment, the operational data store 157 provides data to the aggregated data store 165 by performing one or more data batch uploads at a predetermined interval and/or upon receipt of a data upload request (e.g., at the operational data management application 155).

The aggregated environment 161 can also include an engagement tracker 167 that tracks interactions of a client with electronic communications that may be generated at and transmitted from the aggregated environment 161. Data from the engagement tracker 167 can be used to optimize machine learning processes and other processes for predicting subject interests and generating recommendations. The engagement tracker 167 can record information including, but not limited to, read receipts, link clicks, content observation metrics, and other information related to interactions with electronic communications. In one example, the engagement tracker 167 includes a review tool embedded within an electronic communication comprising recommendations. In this example, for each recommendation, the review tool receives positive or negative responses (e.g., thumbs-up or thumbs-down inputs) from a user account to which the electronic communication is transmitted. In at least one embodiment, the engagement tracker 167 associates tracked information with at least one user account corresponding to a subject. For example, the engagement tracker 167 may include a subject identifier (for example, a user ID) that is associated with a subject whose interaction with an electronic communication is being tracked. The subject identifier can be included in a data object sourced from a tracked interaction with the electronic communication.

The aggregated environment 161 can include a recommendation engine 169 that analyzes play behavior data (and other associated information) and generates one or more recommendations based on the analysis. In at least one embodiment, the recommendation engine 169 may generate the one or more recommendations by performing machine learning processes to model data. Examples of machine learning processes and models include, but are not limited to, neural networks, random forest classification, and local topic modeling. From the model, the recommendation engine 169 can output the one or more recommendations. The recommendation engine 169 can receive data from the aggregated data store 165 and can provide one or more recommendations (e.g., expressed as electronic data) to the aggregated data store 165 and a communication module 171. The communication module 171 can generate electronic reports and messages based on one or more templates stored therein. The generated electronic reports may include analysis results and recommendations produced by the recommendation engine 169. The communication module 171 can transmit generated electronic reports to the client device 175. Thus, the aggregated environment 161 may receive data describing play behavior, store the data in the aggregated data store 165, collect engagement information, generate analyses of the play behavior data, generate one or more recommendations, generate electronic reports including analysis results and the one or more recommendations, and transmit reports to the client device 175 and/or the website 159.

The client device 175 is representative of a plurality of client devices that may be coupled to the network 108. The client device 175 may include, for example, a processor-based system such as a computer system. Such a computer system may be embodied in the form of a desktop computer, a laptop computer, personal digital assistant, cellular telephone, smartphone, set-top box, music player, web pad, tablet computer system, game console, electronic book reader, or one or more other devices with like capability. The client device 175 may include a display (not illustrated). The display may include, for example, one or more devices such as liquid crystal display (LCD) displays, gas plasma-based flat panel displays, organic light-emitting diode (OLED) displays, electrophoretic ink (E ink) displays, LCD projectors, or other types of display devices, etc. Thus, the client device 175 may possess all components, applications and functions necessary to provide and receive data, via the network 108, to and from the operational environment 151, the aggregated environment 161 and the website 159. Also, the display of the client device 175 may be suitable for visualizing received data (for example, analysis results and one or more recommendations).

The client device 175 can receive electronic communications from the communication module 171. The client device 175 can render received electronic communications on an included display. For example, the client device 175 can render, on a display, visualizations of one or more subject metrics (as described herein) and one or more recommendations. Because the client device 175 can facilitate interaction of a subject with received electronic communications, the client device 175 can also be a source of engagement data. For example, the engagement tracker 167 can collect, from trackable content accessed via the client device 175, engagement data associated with interaction of a client with received electronic communications.

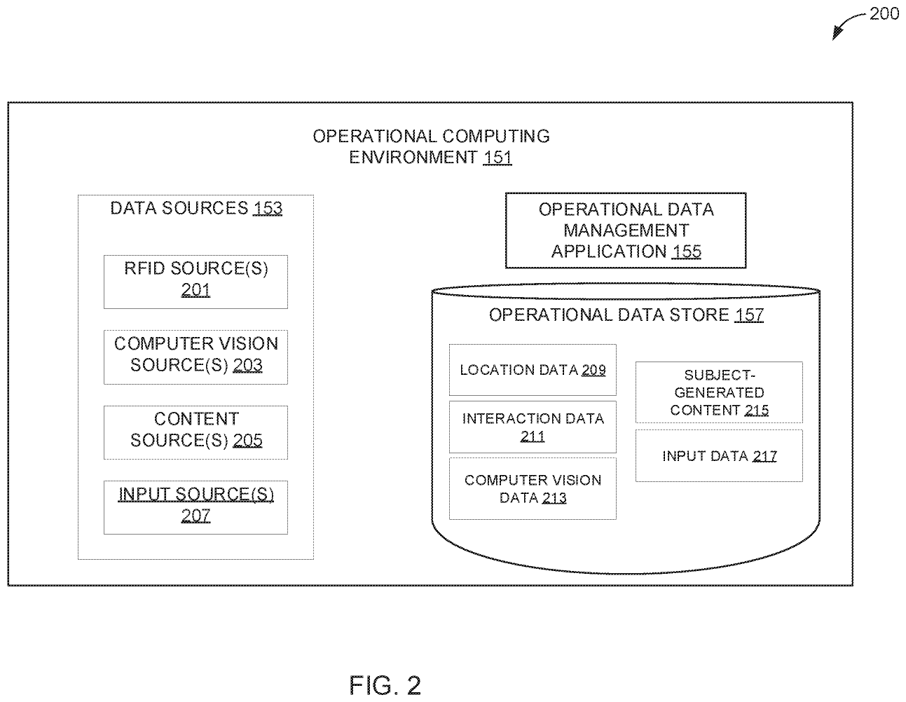

With reference to FIG. 2, shown is an operational computing architecture 200 according to various embodiments. The data sources 153 can include RFID sources 201, computer vision sources 203, content sources 205, and input sources 207. The RFID sources 201 can be one or more radio frequency identification (“RFID”) readers that may be placed throughout a particular physical environment. The RFID sources 201 can be coupled to the network 108 (FIG. 1B). The RFID readers can interrogate RFID tags that are within range of the RFID readers. The RFID reader can read the RFID tags via radio transmission and can read multiple RFID tags simultaneously. The RFID tags can be embedded in various objects, such as toys, personal tags, or other objects. The objects may be placed throughout a play area for children. The RFID sources 201 can interact with both passive and active RFID tags. A passive tag may refer to an RFID tag that contains no power source, but, instead, becomes operative upon receipt of an interrogation signal from an RFID source 201. Correspondingly, an active tag refers to an RFID tag that contains a power source and, thus, is independently operative. In addition to an RFID tag, the active tags can include an RFID reader and thus function as an RFID source 201. The active tag can include a long-distance RFID antenna that can simultaneously interrogate one or more passive tags within a particular proximity of the antenna.

The RFID sources 201 and RFID tags can be placed throughout a particular physical area. As an example, the RFID sources 201 can be placed in thresholds such as at doors, beneath one or more areas of a floor, and within one or more objects distributed throughout the play area. In one embodiment, the RFID sources 201 can be active RFID tags that are operative to communicate with the operational data management application 155. In various embodiments, the RFID tags may be embedded within wearables, such as wristbands, that are worn by children present in a play area.

The RFID sources 201 and RFID tags may each include a unique, pre-programmed RFID identifier. The operational data store 157 can include a list of RFID sources 201 and RFID tags including any RFID identifiers. The operational data store 157 can include corresponding entities onto or into which the RFID sources 201 or RFID tag are disposed. The operational data store 157 can include locations of the various RFID sources 201 and RFID tags. Thus, an RFID identifier can be pre-associated with a particular section of a play area, with a particular subject, with a particular or object, or a combination of factors. The RFID tags can include the RFID identifier in each and every transmission sourced or a subset therefrom.

Passive RFID tags can be interrogated by RFID sources 201 that include active tags and that are distributed throughout a play area. For example, a passive RFID tag may be interrogated by active RFID tag functioning as an RFID source 201. The RFID source 201 can interrogate the passive RFID tag upon movement of the passive RFID tag within a predefined proximity of the active RFID source 201. The RFID source 201 can iteratively perform an interrogation function such that when the passive RFID tag moves within range, a next iteration of the interrogate function interrogates the passive RFID tag. Movement of a passive RFID tag within a predefined proximity of an RFID source 201 (e.g., wherein the movement triggers an interrogation or the interrogation occurs iteratively according to a defined frequency) may be referred to herein as a “location interaction.” The predefined proximate can correspond to a reading range of the RFID source 201.

The operational data management application 155 may receive a transmission from an RFID source 201 following each occurrence of a location interaction. A transmission provided in response to a location interaction may include a first RFID identifier that is associated with a passive tag and a second RFID identifier that is associated with an RFID source 201. In some embodiments, the transmission may include a transmission from both a passive and active tag, or may only include a transmission from an active tag. In instances where a transmission is provided only by an active tag (e.g., an active tag that has experienced a location interaction with a passive tag), the active tag may first receive an interrogation transmission from the passive tag, the interrogation transmission providing a first RFID identifier that identifies the passive tag. In some embodiments, the transmission can include multiple RFID identifiers associated with more than one passive tag. The RFID source 201 may read more than one RFID tag located within a reading range. The RFID source 201 may transmit a list of RFID identifiers for the RFID tags read along with an RFID identifier for the RFID source 201.

As one example, a child in a play area may wear a wristband that includes a passive RFID tag. The child may walk through a threshold into a particular area of the play area. The threshold may include an RFID source 201 that interrogates the child's RFID tag, thereby causing a location interaction. The location interaction may include, but is not limited to, the RFID tag receiving an interrogation signal from the RFID source 201, the RFID tag entering a powered, operative state and transmitting a first RFID identifier to the RFID source 201, and the RFID source 201 transmitting the first RFID identifier and a second RFID identifier (e.g., that is programmed within the RFID source 201) to an operational data management application 155. The operational data management application 155 can process the transmission and store data to an operational data store 157. The operational data management application 155 can determine the child is now within the particular area based on receiving the first RFID identifier and the second RFID identifier. The operational data management application 155 can utilize data relating the first identifier to the child and the second identifier to the particular area. Thus, a location interaction may allow the present system to record movement of a subject throughout a play area and, in particular, into and out of one or more particular areas of the play area.

The RFID sources 201 can also be included in one or more experiences configured and/or installed throughout a play area. In various embodiments, an experience may include, but is not limited to, a particular object (or set of objects), an apparatus and an interactive location provided in a play area. For example, an experience may include a particular train and a particular train zone of a play area. The particular train may include a passive RFID tag and the particular train zone may also include an RFID source 201 (e.g., disposed within a particular floor section of a play area). The RFID tag of the particular train and the RFID source 201 of the train zone may be in communication with each other. The RFID source 201 of the train zone and/or RFID tag of the particular train may also be in communication with an RFID tag of a subject (e.g., a subject wearing an RFID wristband) that enters the train zone and plays with the particular train. Per the present disclosure, an instance where communicative RFID activity occurs between a subject and an object and/or experience may be referred to as an “experience interaction.” Accordingly, the present system may receive (e.g., via transmissions from RFID sources 201) data associated with any experience interaction occurring within a play area.

The data sources 153 can include other trigger- and/or detection-based sources including, but not limited to, projection sources, scanners, motion sensors, WiFi-based sources, and other electronic devices and apparatuses that can be triggered by or detect a subject. For example, a play environment can include one or more projection sources that include a motion sensor. The motion sensor can detect a subject, upon the subject moving within a predefined proximity of the motion sensor. Following detection, the motion sensor can trigger the one or more projection sources to display content. The one or more projection sources can also include a WiFi-based source that communicates with one or more additional projection sources and, in response to the first triggered projection, triggers subsequent displays of content.

In an exemplary scenario, a child walks into a dinosaur-themed play room.

Initially, a projection source in the room displays a scene of a mother pterodactyl and a nest of pterodactyl eggs. Upon entering the room, an RFID source 201 interrogates the child's RFID wristband and a motion sensor (installed within the projection source) detects movement of the child within a predefined proximity of the motion sensor. The motion sensor can trigger the projection source to generate a new display of a carnivorous dinosaur stealing the pterodactyl eggs, and the mother pterodactyl requesting assistance of the child in finding the stolen eggs. The room can include one or more egg-shaped elements (e.g., objects, surfaces, etc.) that include RFID sources 201. The child can then explore the room to “find” the eggs by placing their RFID wristband against the eggs (thereby causing interrogation of the wristband by the RFID sources 201). The present system can determine when the child “finds” a predetermined number of eggs (to increase ease of the task, the room can include a greater number of egg elements compared to a number of eggs included in the display). Upon determining that the child has “found” the predetermined number of eggs, the system can trigger the projection source to display a scene of the eggs hatching. As described herein, the system can process data collected by the data sources 153 during the child's time in the dinosaur room and can determine one or more interests of the child and one or more metrics and/or insights regarding play behavior of the child. For example, the system can determine that the child is interested in herbivorous dinosaurs, enjoys helping others and enjoys “scavenger-hunt”-like play experiences.

The computer vision sources 203 can include one or more computer vision apparatuses placed throughout a play area. The computer vision sources 203 can include an overhead camera, a wall-mounted camera, or some other imaging device. The computer vision sources 203 can stream a live or recorded video stream to the operational data management application 155. In some embodiments, one of the computer vision sources 203 can provide an infrared video stream. A computer vision apparatus may include, but is not limited to, an imaging component that collects visual data from a play area, a processing component that processes and analyzes collected visual data, and a communication component that is operative to transmit collected and/or processed visual data and, in some embodiments, analysis results to an operational computing environment 151 and, in particular, to an operational data management application 155. In some embodiments, the computer vision sources 203 may include only an imaging component and a communication component, and analysis of collected and/or processed visual data may occur elsewhere (for example, in an operational computing environment 151 or in an aggregated computing environment 161). Visual data collected by the computer vision sources 203 may be processed and/or analyzed using one or more computer vision algorithms to obtain one or more computer vision outputs. The computer vision outputs can include, but are not limited to, traffic patterns that illustrate movement trends of subjects through a play area (or a particular area of a play area), dwell times that indicate time spent by one or more subjects in a play area (or a particular area), and object recognitions that identify a particular object in a play area, and may also identify an action being performed on the particular object.

For example, the computer vision sources 203 may collect visual data of a child playing with a train and train tracks in a toy room of a play area. The computer vision sources 203 may send the collected visual data to the operational data management application 155. The operational data management application 155 can analyze the visual data using one or more computer vision algorithms to generate one or more computer vision outputs. Based on the outputs, the operational data management application 155 can identify movement of the child into the toy room, provide a dwell time of the child within the toy room, and identify the train with which the child played. The system can also identify that the child constructed a toy railroad, and can determine that the child used blocks and other non-train toys to construct a railroad bridge crossing a projected river display, thereby suggesting a potential interest in construction (identified by the system, as described herein).

The content sources 205 can include one or more devices, assemblies and/or apparatus that allow a subject to produce customized content. For example, a content source 205 can be a toy review station where a child can record their own review of a toy and assign the toy a rating. The content sources 205 can include a communication component that provides subject-generated content (e.g., reviews, ratings, etc.) to an operational data management application 155. In some embodiments, communications from a content source 205 may also include an identifier associated with the subject that produced the subject-generated content. Thus, the content sources 205 may provide the present system with data that identifies a subject and provides subject-generated content produced by the subject (via the content sources 205).

The input sources 207 can include one or more electronic devices that receive manual input from a system operator (for example, an employee monitoring subjects within a play area). The input sources 207 can also include an RFID interrogation component that allows the system operator to interrogate RFID tags, or the like, of one or more subjects in the play area (e.g., to identify the one or more subjects via RFID identifiers). The input sources 207 can include, but are not limited to, desktop computers, laptop computers, personal digital assistants, cellular telephones, smartphones, web pads, and tablet computer systems. In at least one embodiment, the system includes, in the input sources 207, an interface for entering manual inputs. The interface can include one or more pre-generated forms and/or templates with fields for inputting various subject information, subject data, metrics, and other observations. The input sources 207 can be operative to communicate with an operational data management application 155. The input sources 207 can communicate received inputs to the operational data management application 155 via a network (for example, a network 108 illustrated in FIG. 1B). Inputs received by the input sources 207 can include, but are not limited to, an identifier (e.g., such as an RFID identifier as described herein) that is associated with a subject, object, location, etc., observations of subject play behavior within a play area (or a particular area thereof), observations of play trends within a play area (for example, an observation that a particular play experience is most popular amongst subjects), and other information and/or data related to activities, subjects, objects and locations in a play area. The inputs can be in one or more formats including, but not limited to, character strings, numeric values, and Boolean values.

As described herein, the operational data management application 155 may receive data from one or more data sources 153. The operational data management application 155 can process and convert received data into one or more formats prior to providing the data to the operational data store 157. The operational data store 157 may organize collected and received data in any suitable arrangement, format, and hierarchy. For purposes of description and illustration, an exemplary organizational architecture is recited herein; however, other data organization schema are contemplated and may be utilized without departing from the spirit of the present disclosure.

The operational data store 157 may include location data 209. The location data 209 can include data associated with RFID location interactions (as described herein). The location data 209 can include RFID identifiers associated with one or more subjects and one or more locations (e.g., in a play area where RFID sources 201 have been placed). The location data 209 may be time series formatted such that a most recent entry is a most recent location interaction as experienced by a subject and a particular location in a play area, and recorded via RFID sources 201. Accordingly, the location data 209 can serve to illustrate movement of a subject into and out of a particular location in a play area. One or more entries associated with a location interaction may include, but are not limited to, a subject RFID identifier, a location RFID identifier, and a timestamp associated with the location interaction.

In an exemplary scenario, a subject with an RFID wristband (as described herein) crosses a threshold (e.g., a doorway) that includes an RFID source 201. In the same scenario, as the subject passes within a predefined proximity (for example, 1 m) of the RFID source 201, the RFID source 201 interrogates the RFID wristband and receives a subject RFID identifier. Continuing the scenario, the RFID source 201 transmits data (e.g., the subject RFID identifier, a location RFID identifier and metadata) to an operational data management application 155. The operational data management application 155 can receive and process the data, and provide the processed data (e.g., now location data 209) to an operational data store 157. The operational data store 157 can organize and store the location data 209. Organization activities of the operational data store 157 can include, but are not limited to, updating one or more particular data objects, or the like, to include received location data 209 and/or other data (as described herein). In at least one embodiment, the operational data store 157 may organize particular location data 209, or any data, based on an associated subject RFID identifier (e.g., where the association is that the subject identifier was received concurrently with the data to be organized).

The operational data store 157 can include interaction data 211. The interaction data 211 can be sourced from experience interactions and data thereof. Thus, interaction data 211 can include data associated with RFID object and experience interactions. The location data 209 can include data including, but not limited to, RFID identifiers associated with one or more subjects and one or more experiences (e.g., that provided in a play area and include RFID sources 201). The interaction data 211 may be time series formatted such that a most recent entry is a most recent experience interaction as experienced by a subject, one or more objects, and/or particular regions of a play area, and recorded via RFID sources 201. Accordingly, the interaction data 211 can serve to illustrate instances where a subject experienced a particular experience interaction in a play area. One or more entries associated with an experience interaction may include, but are not limited to, a subject RFID identifier, one or more object RFID identifiers, a location RFID identifier, and a timestamp associated with the experience interaction.

In an exemplary scenario, a subject with an RFID wristband engages with an experience that includes an RFID source 201. In the same scenario, as the subject passes within a predefined proximity (for example, 1 m) of the RFID source 201, the RFID source 201 interrogates the RFID wristband and receives a subject RFID identifier. Continuing the scenario, the RFID source 201 (and/or the RFID wristband) transmits data (e.g., the subject RFID identifier, one or more object RFID identifiers, a location RFID identifier and metadata) to an operational data management application 155. In the same scenario, the operational data management application 155 receives and processes the data, and provides the processed data (e.g., now interaction data 211) to an operational data store 157. Continuing the scenario, the operational data store 157 organizes and stores the location data 209.

The operational data store 157 can include computer vision data 213. The computer vision data 213 can include processed or unprocessed image data (and metadata) from one or more computer vision sources 203. Accordingly, the operational data management application 155 may receive data from the computer vision sources 203, process the data (if required) and provide the data (e.g., as computer vision data 213) to the operational data store 157 that organizes and stores the provided data. Also, the operational data store 157 can include subject-generated content 215 that is received from one or more content sources 205. Accordingly, the operational data management application 155 may receive data (including subject-generated content) from the content sources 205, process the data (if required) and provide the data (e.g., as subject generated content 215) to the operational data store 157 that organizes and stores the provided data. The subject-generated content 215 may include a subject identifier (for example, a user ID, subject RFID identifier, etc.) that is associated with a particular subject that produced the subject generated content 215. Thus, the present system may track and store subject-generated content 215 and associate (programmatically, in a database) a subject with the subject-generated content 215.

The operational data store 157 can include input data 217. The input data 217 can include free form and/or numerical information, such as text descriptions and numeric ratings, that are sourced from one or more input sources 207. The input data 217 can also include one or more subject identifiers (for example, a subject RFID identifier, user ID, etc.) that associates the input data 217, or at least one data object thereof, with a particular subject (e.g., that played or is currently playing in a play area). The input data 217 can include data from surveys and profiles that are populated based on inputs of a subject or other user, such as a guardian of the subject or a staff member of a play environment. In one example, input data 217 includes observational data entered by a staff member that observes play behavior of a child in a music-themed toy room. In another example, input data 217 includes feedback from a survey response submitted by a parent, the survey being presented to the parent based on their child's admittance to and/or departure from a play environment. The input data 217 can provide additional information regarding a subject, such as known interests, disinerests, and play behaviors. In one example, a subject (or guardian thereof) is presented a survey associated with the subject's user account, the survey including a plurality of questions associated with play behavior of the subject and being directed towards assessing the interests and cognitive development of the subject. In this example, the responses to the survey (e.g., which may be received via a client device 175) are saved in the aggregated computing environment 161 (or other appropriate location) and may be retrieved to augment interest prediction and recommendation processes for the subject.

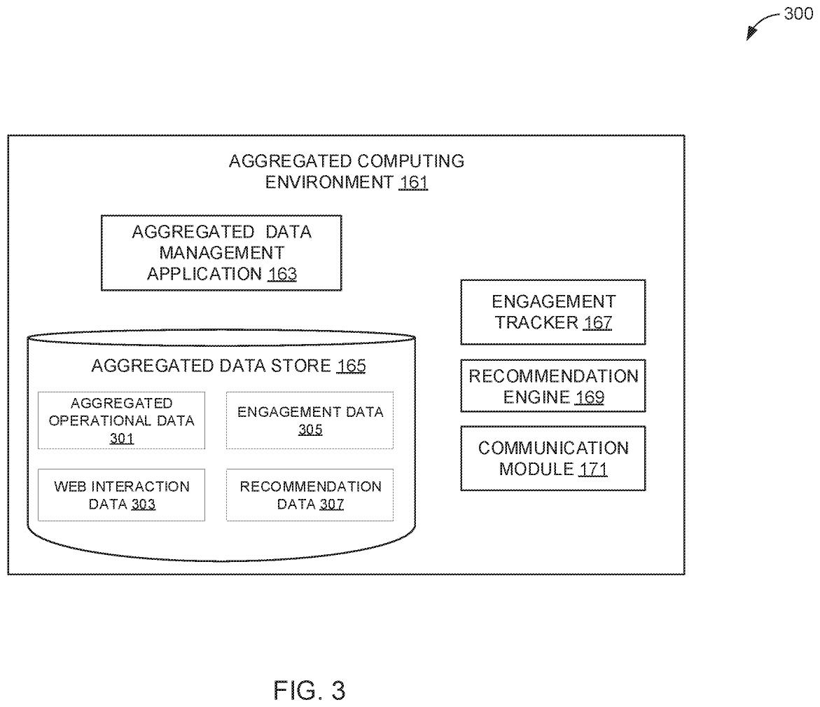

With reference to FIG. 3, shown is an aggregated computing environment architecture 300, according to various embodiments. The aggregated computing environment 161 may include, but is not limited to, an aggregated data management application 163, an aggregated data store 165, an engagement tracker 167, a recommendation engine 169, and a communication module 171. The aggregated data store 165 can include aggregated operational data 301. The aggregated operational data 301 can include location data 209, interaction data 211, computer vision data 213, subject-generated content 215, and input data 217. The aggregated operational data 301 can be updated through multiple uploads from the operational data store 157. Because the aggregated data store 165 can receive regular uploads of data, the aggregated operational data store 165 may continuously update the aggregated operational data 301 to include most recently uploaded data.

The aggregated data store 165 can also include web interaction data 303. The web interaction data 303 can refer to data sourced from recorded interactions of one or more subjects with at least one website 159. The aggregated data management application 163 can receive the web interaction data 303 from a web interaction tracking module (not illustrated) that is running on the one or more websites 159. The web interaction data 303 can include, but is not limited to, website interaction data objects, or the like, that associate a particular subject with one or more aspects of the website 159 with which the subject interacted. The web interaction data 303 may provide information regarding one or more particular interests, trends, and/or affiliations of one or more subjects (e.g., that interacted with the website 159).

The aggregated data store 165 can include engagement data 305. The engagement data 305 can be sourced from the engagement tracker 167. The engagement data 305 can include, but is not limited to: 1) read receipts; 2) link clicks; 3) content observation metrics; and 4) other information related to interactions with electronic communications. The engagement data 305 may be organized (e.g., by the aggregated data store 165) into one or more data objects. Also, the one or more data objects may be organized based on one or more subject identifiers (e.g., a user ID) that are included in the engagement data 305. For example, the engagement data 305 may include at least one data object (such as a data array) for each subject whose interaction with an electronic communication has been tracked (e.g., by the engagement tracker 167).

The aggregated data store 165 can also include recommendation data 307. The recommendation data 307 can include historical data sourced from one or more recommendations generated by the recommendation engine 169. In various embodiments, the recommendation data 307 includes historical recommendation information relating to one or more of toys, games, events, off-site activities, on-site activities, and resources. The recommendation data 307 can be associated with each of one or more subjects to which the one or more recommendations were provided (e.g., via the communication module 171). In at least one embodiment, associations between the recommendations and each of the subjects may be sourced from the subject identifiers (e.g., user IDs) that are each uniquely associated with a subject (e.g., that interacted with an electronic communication provide by the communication module 171).

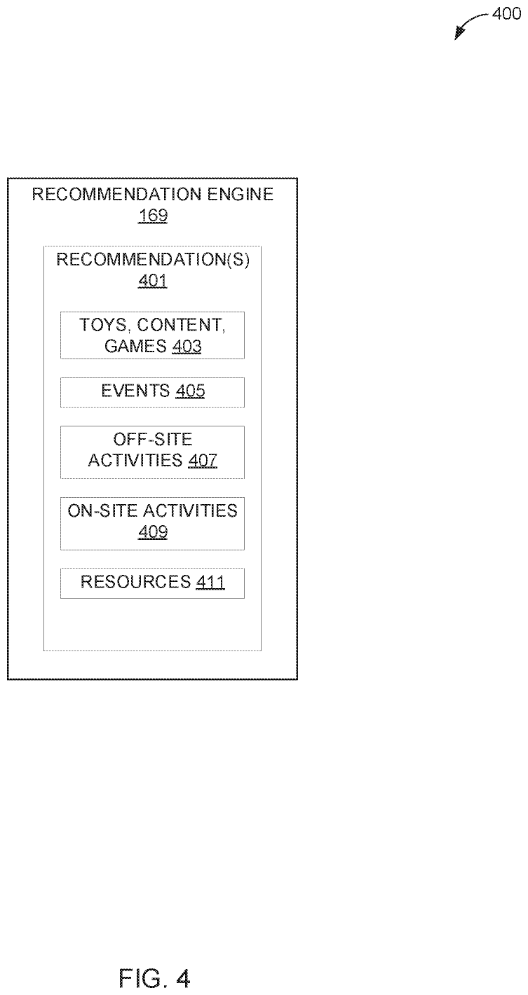

With reference to FIG. 4, shown is a recommendation engine architecture 400 according to various embodiments. The recommendation engine 169 can analyze data (e.g., from the aggregated data store 165) and generate one or more recommendations 401. In other words, the recommendation engine 169 can, using collected data, analyze and evaluate play behavior of a subject in a play area, and generate outputs (or generate a model that produces outputs) that are recommendations for additional objects, experiences, etc. that the subject may enjoy. The recommendations 401 can be recommendations for toys and games 403, for events 405, for off-site activities 407, for on-site activities 409 and for resources 411. Accordingly, in at least one embodiment, the recommendation engine 169 may include or be operatively connected to one or more databases containing information related to toys and games 403, events 405, off-site activities 407, on-site activities 409 and resources 411. The recommendation engine 169 can receive, from the third party service 173, information regarding toys, games, events, off-site activities, on-site activities, and resources that may be used in one or more recommendations 401.

Recommendations 401 for toys and games 403 can include information (for example, clickable web links) that directs a subject to a website 159 and/or a third-party service 173 from which the subject may acquire the toys and games 403. For example, the recommendation engine 169 may analyze collected data on a child in a jungle play area that, based on the collected data, enjoys playing with safari animal toys. In the same example, the recommendation engine 169 may generate a recommendation 401 for a set of safari animal toys. Recommendations 401 for events 405 may include information that describes an upcoming event that may be of interest to a subject, based on collected and evaluated subject play behavior. Continuing the above example, the recommendation engine 169 may include, in a recommendation 401, a description and web link for an upcoming debut of a new giraffe at a zoo.

Recommendations 401 for off-site activities 407 may include information that describes an activity (e.g., to be performed outside of the play area) that may be of interest to a subject, based on collected and evaluated subject play behavior. An off-site activity 407 can include, but is not limited to, games, learning exercises, conversations, and other activities that can be performed off-site by a subject. The recommendation engine 169 may include, in a recommendation 401, a description for a safari simulation activity where a child and guardian explore a local park for interesting wildlife. Recommendations 401 for on-site activities 409 may include information that describes an on-site activity (e.g., to be performed during a return visit the play area) that may be of interest to a subject, based on collected and evaluated subject play behavior. An on-site activity 409 can include, but is not limited to, movie nights, game nights, performances, seminars, and other activities and experiences that may occur at a play area. Continuing the above example, the recommendation engine 169 may include, in a recommendation 401, a description for an upcoming safari adventure film night that a child may attend at the play area.

Recommendations 401 for resources 411 may include information that describes a resource (and courses for acquiring and/or accessing the resource) that may be of interest to a subject, based on collected and evaluated subject play behavior. Resources 411 can include, but are not limited to, informative media (for example, informative websites, literature, articles, blogs, seminars, etc.) and contact and other information for informative and/or assistive entities. Continuing the above example, the recommendation engine 169 may include, in a recommendation 401, a description for a safari animal encyclopedia that a child may read to learn more about safari animals.

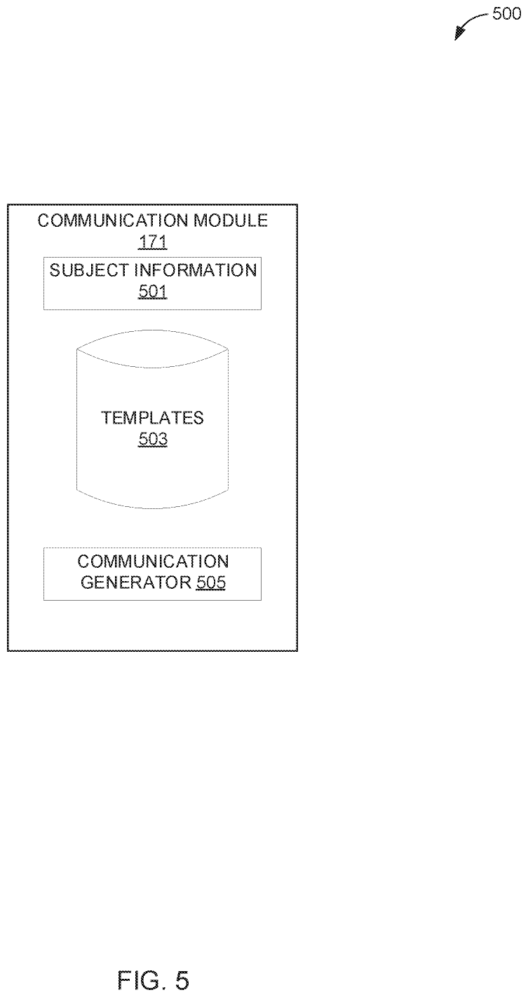

With reference to FIG. 5, shown is a communication module architecture 500 according to various embodiments. The communication module 171 can include subject information 501. The subject information 501 can include contact information for one or more subjects that visit a play area and/or access the website 159. The subject information 501 can be stored in one or more databases included in or operatively connected to the communication module 171. In at least one embodiment, the subject information includes only subject identifiers (for example, user IDs), and identifying information for corresponding subjects may be stored elsewhere (for example, in a secured third party database, in a separate cloud database, etc.). Thus, in at least one embodiment, the subject information 501 may be effectively anonymized. The communication module 171 can also include one or more templates 503. The one or more templates 503 can be templates for electronic communications that are used by a communication generator 505 to construct and populate personalized communications for one or more subjects. For example, a template 503 can be an email template with fields for inserting subject information 501, one or more recommendations 401 and, in some embodiments, descriptions of play behavior (generated by the present system) of the subject during a visit to the play area. The communication generator 505 can include a processor that retrieves and converts subject information 501, templates 503, recommendations 401, and descriptions of play behavior into a formalized, professional electronic communication. The communication generator 505 can also include and/or be operatively connected to a server that transmits generated electronic communications.

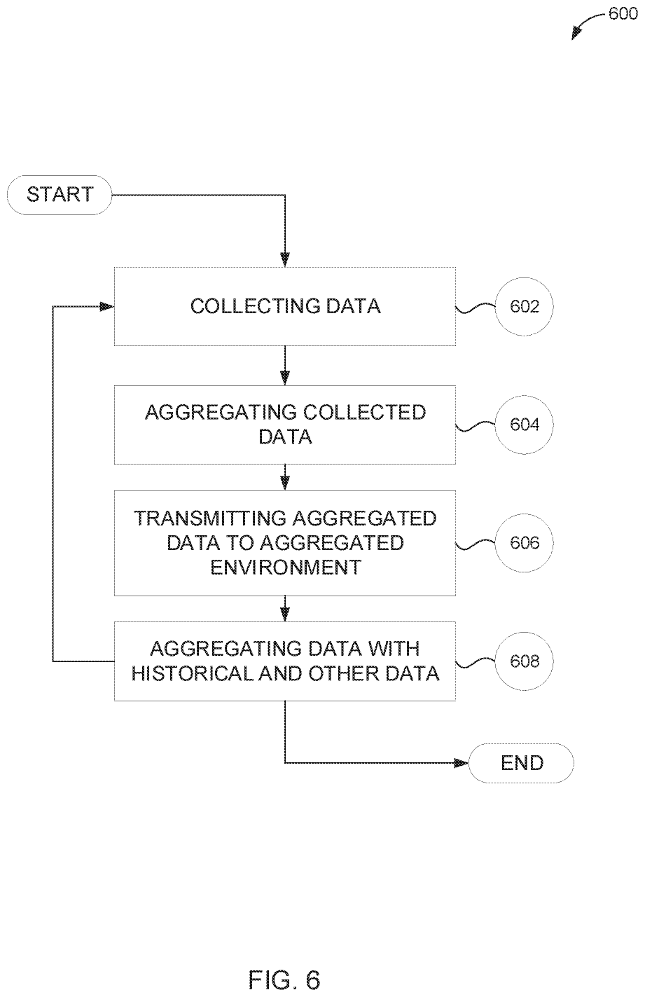

With reference to FIG. 6, shown is a data aggregation flowchart 600, according to various embodiments. As will be understood by one having ordinary skill in the art, the steps and processes shown in FIG. 6 (and those of all other flowcharts and sequence diagrams shown and described herein) may operate concurrently and continuously, are generally asynchronous and independent, and are not necessarily performed in the order shown. As an alternative, the flowchart of FIG. 6 may be viewed as depicting an example of elements of a method implemented in the operational computing environment 151 according to one or more embodiments.

At step 602, the system collects data from a play area. The collecting can be performed by one or more data sources, for example, data sources 153 (FIG. 1B), and data can be transmitted to the operational data management application 155 (FIG. 1B). The operational data management application 155 can process and provide the data to the operational data store 157 (FIG. 1B). Data collection can occur at one or more predetermined frequencies and/or may occur continuously. In at least one embodiment, data collection can be performed automatically and/or manually.

At step 604, the system aggregates operational data. Operational data aggregation can include, but is not limited to, associating data with a specific subject (for example, via a subject identifier). To achieve operational data aggregation, the system can organize data collected within a predetermined interval (for example, one day) by associating the collected data with a subject identifier and, in some embodiments, generating one or more data objects. In various embodiments, each data object may include data associated with at least one subject (e.g., as indicated by a subject identifier therein). Operational data aggregation may be performed at one or more servers included in and/or operatively connected to the system.

At step 606, the system transmits, via a network, aggregated operational data to an aggregated computing environment 161 (FIG. 1B). Specifically, the system can transmit the aggregated operational data to an aggregated data management application 163 (FIG. 1B). Aggregated operational data transmission can occur at one or more predetermined frequencies and/or may occur continuously. In at least one embodiment, aggregated operational data transmission can be performed automatically and/or manually. In at least one embodiment, the present system performs aggregated operational data transmission by uploading, via a server, the aggregated operational data to a cloud computing environment (which may be the aggregated computing environment) that provides long term data storage services.

At step 608, the system further aggregates the transmitted aggregated operational data with historical data (e.g., previously received aggregated operational data) and other data, including but not limited to, web interaction data, engagement data, and recommendation data. The system can perform data aggregation by appending received aggregated operational data to the historical data. The system may organize the newly aggregated data by subject identifier, by date, by location collected (e.g., by location RFID identifier), by room (e.g., room of a play area) and/or by a combination of elements described herein. All aggregated data (and, by extension, all data in the present system) may be organized and stored using subject identifiers (such as user IDs) that do not include personally identifying information. In at least one embodiment, the system stores all data anonymously and performs subject communication activities by matching a subject identifier with a database of subject identifying information (for example, a database that relates user IDs to subject email addresses). Finally, the steps illustrated in FIG. 6 may occur continuously and with repetition such that data is collected and aggregated operationally and globally on a continual basis.

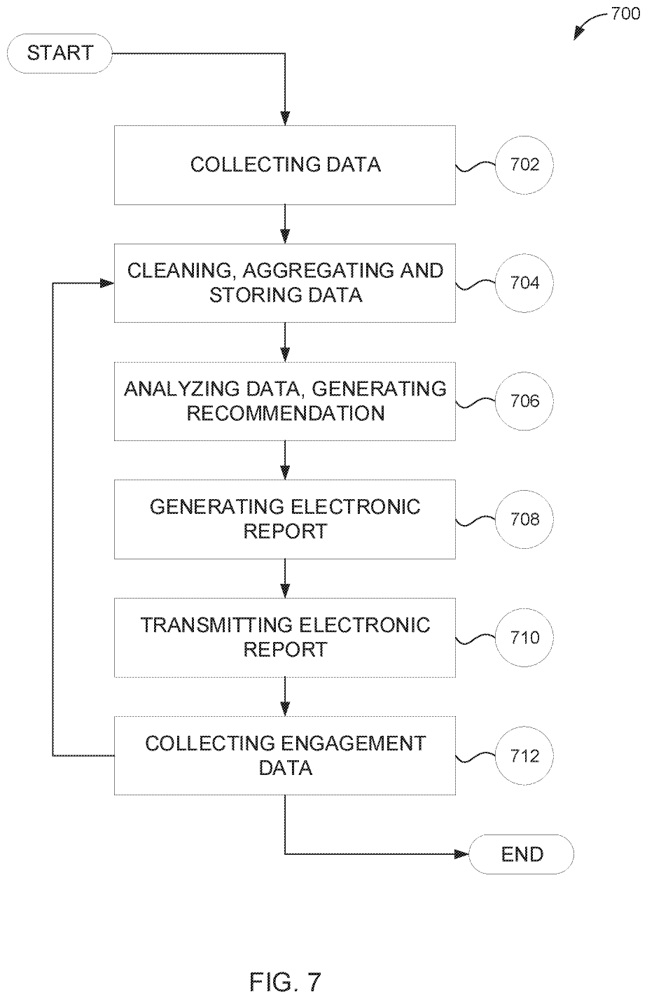

With reference to FIG. 7, shown is a recommendation flowchart 700 according to various embodiments. As an alternative, the flowchart 700 of FIG. 7 may be viewed as depicting an example of elements of a method implemented in the aggregated computing environment 161 (FIG. 1B) according to one or more embodiments. At step 702, data documenting play behavior of a subject in a play area is collected. The data can be collected (e.g., or received) from one or more data sources dispersed throughout a physical environment, such as, for example, data sources 153 (FIG. 1B). In at least one embodiment, the one or more data sources can include, but are not limited to, RFID sources, computer vision sources, content sources, input sources, WiFi sources, Bluetooth sources, motion sensors, and other sources that generate data in response to detected physical phenomena. As described herein, collected and/or received data may be transmitted, via network, to an operational computing environment where the data is processed at an operational data management application and operationally aggregated, organized, and stored at an operational data store. The operational data store can include, but is not limited to, location data, interaction data, computer vision data, input data, and subject-generated content.

Data can also be collected from one or more websites 159 (FIG. 1B). The website data can include information describing interactions of the subject with website content. For example, the website data can include, but is not limited to: 1) links (e.g., that the subject clicked); 2) forms filled out by the subject; 3) content viewed by the subject (for example, videos); and 4) other website analytics. The website data can be collected and/or received from a website interaction database, or the like, that stores historical website data (e.g., and organizes the historical web site data based on one or more subject identifiers. The website data can be collected by the operational computing environment and/or by an aggregated computing environment.

At step 704, data in the operational data store is transmitted to an aggregated computing environment 161. The data can be received and processed at an aggregated data management application. Data processing, at the aggregated management application, can include one or more processes and techniques for cleaning data. The one or more processes can include, but are not limited to removing and/or imputing missing data values, null data values, duplicate data values, and other potentially erroneous and/or outlier data values. Following processing at the aggregated data management application, the cleaned data can be provided to an aggregated data store. The aggregated data store 165 (FIG. 1B) can include aggregated operational data, web interaction data, engagement data, and recommendation data. The aggregated data store can organize the cleaned data with historical data therein by appending the cleaned data to historical data that is associated with the subject. In at least one embodiment, the aggregated data store can organize data by subject, by date, by location and/or source collected, by play area region (e.g., a specific section of a play area). In various embodiments, the aggregated data may organize data based on any data element or subject factor provided herein and other data organization schema are contemplated. The aggregated data store can organize data automatically and/or manually (e.g., in response to receipt of a command at a server operatively connected to the data store).

At step 706, the system initiates a data analysis, evaluation, and recommendation generation process. A recommendation engine 169 (FIG. 1B) can perform any and/or all processes involved in analyzing and evaluating subject data, and generating a recommendation. In some embodiments, data analysis and evaluation may be performed at one or more other processors, and results thereof may be provided, via a network, to the recommendation engine. The recommendation engine can automatically and/or manually retrieve data on a subject (or a plurality of subjects) from the aggregated data store. In at least one embodiment, the recommendation engine retrieves data from the data store by providing a data request that specifies a subject identifier, or other organizational key, indicating a specific set of data to be retrieved from the operational data store.

The recommendation engine can perform analytical and evaluation processes that may include, but are not limited to, algorithmic techniques and/or data modeling methods. By performing analytical and evaluation processes, the recommendation engine can compute one or more subject metrics. The one or more subject metrics can include, but are not limited to, time spent in each room and/or section of a play area, number of times the subject participated in a specific activity or experience, one or more toys that the subject played with most frequently, one or more toys that the subject included in subject-generated content (for example, one or more toys that the subject reviewed and rated), and one or more socialization metrics (for example, metrics that indicate whether the subject moved through the play area alone or with other subjects).

To generate the one or more socialization metrics, the recommendation engine can identify two or more subjects that occupied one or more sections of a play area together, that engaged in an experience together and/or that played with a toy together. In particular embodiments, the one or more socialization metrics may be sourced from computer vision sources that identify and track a group of subjects throughout a play area. In some embodiments, the recommendation engine may generate one or more data visualizations (e.g., graphs, charts, etc.), metrics and/or written summaries that describe the one or more subject metrics, and the system may provide the one or more data visualizations, metrics and/or written summaries to the subject, or a guardian thereof, via an electronic communication.

The following paragraph provides an exemplary scenario of the above data collection, organization, and evaluation steps. In an exemplary scenario, a child plays in a play area. As the subject plays, one or more data sources (e.g., data sources 153) collect data that describe the movement of the subject from one room of the play area to other rooms, describe which toys the subject played with, describe whether the child played alone or with others, describe experiences with which the child engaged. The data sources provide the data to an operational computing environment that processes and aggregates the received data and transmits the received data to an aggregated computing environment. The aggregated computing environment receives, processes and organizes the data with historical data associated with the child (e.g., via a subject identifier included in all collected and received data). Following data organization, a recommendation engine retrieves, from an aggregated data store, the received data and other data (for example, web interaction data, engagement data, and other historical data) that is associated with the child. The recommendation engine then applies one or more algorithmic and/or data modeling techniques to analyze and evaluate the retrieved data and generate one or more subject metrics, including dwell time metrics for a period of time that the child spent in each room of the play area. Using the generated dwell time metrics, the recommendation engine generates a pie chart that expresses the child's visit to the play area as percentages of time spent in each room of the play area.

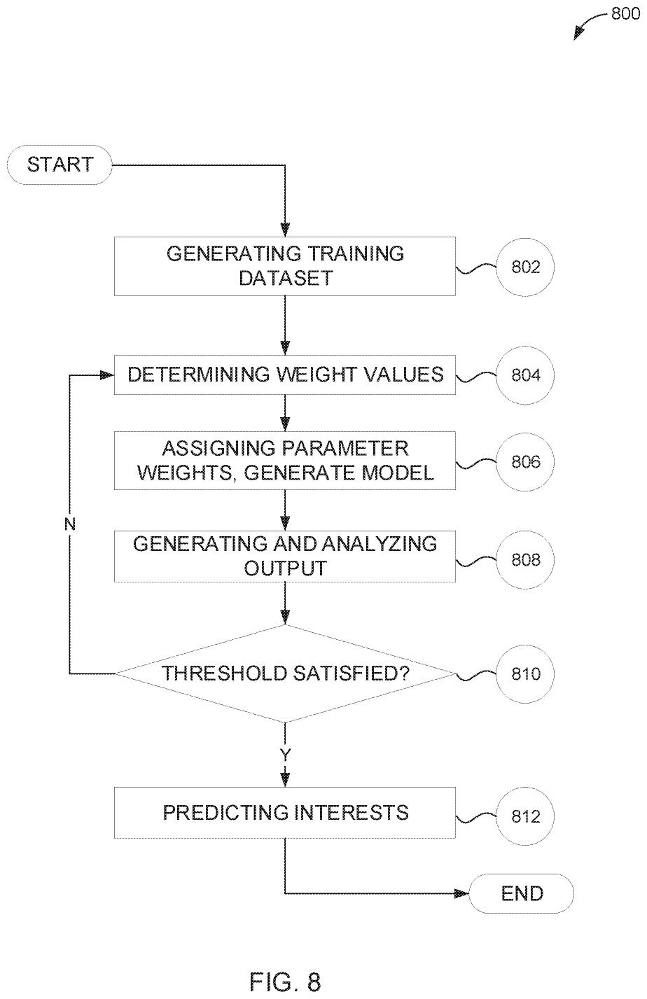

The system can also apply machine learning and/or other artificial intelligence (AI) processes to analyze collected data and generate complex analyses of subject play behavior. In one example, the system performs a machine learning process 800 (FIG. 8) to analyze interaction data and other data and predict interests based on the analysis. The machine learning processes can formulate insights into a subject's cognitive, physical, linguistic, and social-emotional development.

The machine learning processes can formulate analyses of play behavior including, but not limited to, attention span (for example, how long a child interacts with a play environment element and/or plays in each area of the play environment), questioning skills (for example, whether or not a child completed a play objective in a typical or atypical manner), working memory (for example, how much time a child took to perform a memory-based activity compared to average performance times), pattern recognition (for example, how much time a child took to complete a puzzle-based activity and strategies the child utilized to completed the activity), category formation (for example, what types of toys a child played with in combination), problem solving (for example, strategies a child utilized to complete a “scavenger hunt” activity), fine motor skills (for example, how precisely a child played a musical instrument), gross motor skills (for example, whether or not a child was able to operate a push toy), sensory processing (for example, whether a child avoided areas with particular sensory inputs, such as crowds, loud noises, projected content, etc.), decision making, and social and self-awareness (for example, how frequently a child played with others and which role the child occupied when playing with others, such as leader, equal partner, follower, etc.), self-management (for example, how often a child required assistance of a staff member to complete a task or resolve conflict), relationship skills (for example, how a child reacted to a disagreement with another child over turns playing with a toy), and language development (for example, how effectively and how often a child communicated with other children).

The system can also include a set of rules enforced in a play environment. The machine learning and AI processes can analyze collected play data to determine if a subject broke any of the rules while playing in the play environment. For example, a play environment may enforce a rule forbidding explicit hand gestures. The system can analyze computer vision and input data, and determine that a child made an explicit hand gesture. As another example, a play environment may enforce rules forbidding acts of violence and acts of impoliteness and/or theft. The system can analyze computer vision and input data, and determine that a first child struck a second child, after the second child took a toy with which the first child was playing. The system can generate analyses indicating that both children displayed poor social and self-awareness skills, poor self-management skills, and poor relationship skills. The system can include, in an electronic report for each child, a list of rules that the child broke, the circumstances and actions associated with the broken rules, and the skill proficiencies demonstrated by the child. The system can also include, in an electronic report, recommendations for activities and experiences that may mitigate or improve upon deficiencies in skill proficiencies. Continuing the above example, the system may include, in each electronic report, recommendations for team-based sport clubs and for toys and games that require cooperation of two or more subjects and/or award sharing behavior.

Also at step 706, the recommendation engine leverages analyses and evaluations of retrieved subject data to generate one or more recommendations for experiences, activities, resources, and/or objects (e.g., toys, games, etc.) that the subject may enjoy. To generate the one or more recommendations, the recommendation engine performs one or more one machine learning processes to model the retrieved subject data and/or one or more computed subject metrics. The one or more machine learning processes can include, but are not limited to, random forest classification, neural network modeling, gradient boosting, and other machine learning techniques. For example, the recommendation engine can perform random forest classification to generate a machine learning model that predicts interests (e.g., in toys, activities, etc.) of the subject based on determined interests and behaviors of the subject (e.g., as identified via analyses and evaluations of the retrieved data).

The recommendation engine can also make comparisons between one or more subjects. For example, the recommendation engine may compare identified patterns and interests of a first subject to identified patterns and interests of a second subject in order to generate recommendations supported by identified similarities between the first and second subject. In other words, the system can identify interests of a first subject, compare the first subject interest to interests and behaviors of a second subject to influence generation of recommendations for the first subject. For example, the recommendation engine can identify, based on collected behavior data and using present methods, that a first subject enjoys playing with animal toys in a barnyard-themed room of a play area. Continuing this example, the recommendation engine can determine that a second subject with similarly identified interests was provided a recommendation for a barnyard toy set and that the second subject bought the toy set. In the same example, based on determined success of the second subject recommendation, the recommendation engine can generate and provide the first subject with a recommendation for the same barnyard toy set.

In at least one embodiment, the recommendation engine leverages historical data from the aggregated data, or another data source, to train and validate one or more models produced via machine learning methods. Data used to train and validate machine learning models (of the present system) can include, but are not limited to, subject purchase history (e.g., provided by a website 159 and/or a third-party service 173), website analytics (e.g., provided by a website 159), survey responses (e.g., as provided by an engagement tracker 167 and/or a website 159), and manual inputs. The recommendation engine can perform one or more pattern recognition processes (that may or may not include machine learning techniques and/or classification algorithms) to determine one or more patterns from the retrieved data. For example, the recommendation engine may execute a pattern recognition process (on retrieved data) and identify that a subject played with a particular wizard toy in a magic-themed room of a play area. In the same example, the recommendation engine may use an output pattern (e.g., produced via the pattern recognition process) to generate a recommendation for an upcoming magic show occurring in the magic room of the play area. Thus, the present system can record and analyze child play behavior in a play area, and, based on analyses and evaluations of child play behavior, automatically predict child interests and generate recommendations for activities, events, items, and resources with which the child may also find interest (e.g., based on the predicted child interests).

The recommendation engine can format a generated recommendation as one or more data objects that include data identifying a recommended activity, event, item, and/or resource. A generated recommendation may include multiple recommended subject matter. For example, a generated recommendation could be formatted as a data array, each row in the data array describing a distinct toy with which a child may find interest (e.g., as indicated by a recommendation generation process as described herein). In the same example, the generated recommendation may further include, in the same data object or a second data object, data describing an at-home activity with which the child may find interest. In some embodiments, data included in a generated recommendation may include links, or the like, which, when entered into a web browser, direct a subject to subject matter with which the subject may find interest.

The recommendation engine may leverage one or more subject metrics to generate and/or provide additional data in a recommendation. A recommendation can include information including, but not limited to, aggregations of data based on a subject's dwell time in one or more rooms (e.g., expressed as average room times and, in some embodiments, identifying a favorite room as indicated by a maximum dwell time), data associated with a subject's identified favorite toys and/or toy types, social interaction data (for example, whether or not, and for how long, a subject interacted with other subjects in a play area), a favorite play type and/or style (for example, musical, story-driven, building, STEAM, etc.), and long term trends of collected and evaluated behavioral data across multiple visits to a play area.

At step 708, the recommendation engine transmits one or more generated recommendations (and any associated additional information, subject metrics, and visualizations) and a subject identifier to a communication module. The communication module can process the received subject identifier to determine subject information including, but not limited to, subject contact information, such as an email address, subject and/or guardian name, and subject contact preferences. In at least one embodiment, subject information may be provided via one or more calls to an application programming interface (“API”) that provides access to a computing environment (e.g., a server, processor, and database) responsible for maintaining subject information. In some embodiments, the communication generator (instead of the recommendation engine) may generate, at a processor thereof, one or more data visualizations, metrics, and/or written summaries of received subject behavior data.

The communication module can retrieve, from a database thereof, a pre-generated template for an electronic communication. The communication module can provide the received one or more recommendations, the retrieved subject information, and the template to a communication generator that populates the template with appropriate information. For example, the communication generator can process the one or more recommendations to insert appropriate recommendation information into the template. In the same example, the communication generator can process the subject information to insert personalized language and contact information into the template. Continuing this example, the communication generator can convert the template into an electronic communication.

At step 710, following population and conversion of the template into the electronic communication, the communication module (in particular, a server thereof) can transmit, via a network, the electronic communication to the appropriate subject (e.g., as provided via the processed subject information). For example, the communication module can transmit an email to a subject (or a guardian thereof) that includes one or more recommendations and one or more visualizations of collected and evaluated subject data. In some embodiments, the communication module can directly insert one or more electronic offers into the communication (e.g., where the one or more electronic offers are related to the one or more recommendations provided therein). In at least one embodiment, the communication module can embed trackable content, such as read receipts, that allows the system to track and collect information related to a subject's interaction with the electronic communication. For example, links included in the electronic communication may be tracked by the system to determine whether or not a subject has accessed (e.g., clicked) the link and, if so, with what frequency.

In some embodiments, the communication engine can convert the electronic communication into an electronic report that is formatted to be viewed on a web browser (e.g., at a website, such as a website 159 as illustrated in FIG. 1B and described herein). The communication engine can transmit or upload, via a network, the electronic report to a website (in particular, to a server thereof) that processes the electronic report and hosts the electronic report therein. The electronic report can be accessed via a web address that may also be included as a link in the electronic communication.

At step 712, an engagement tracker (for example, the engagement tracker 167 illustrated in FIG. 3 and described herein) collects engagement data as provided by trackable content embedded in the electronic communication. The engagement tracker can collect data including, but not limited to: 1) information, for example a Boolean, that indicates whether or not a subject has opened the transmitted electronic communication; 2) a number of times a subject clicked a link included in the electronic communication; and 3) a duration for which the subject viewed the electronic communication and/or content included therein. The engagement tracker can transmit the collected engagement data and a subject identifier to an aggregated data management application that processes the engagement data and provides the processed engagement data to an aggregated data store. The aggregated data store can aggregate the processed engagement data with historical engagement therein (e.g., that is associated with the subject identifier).

In at least one embodiment, the steps illustrated in FIG. 7 and described herein may be initiated upon detected entry of a subject into a play area. The system may detect entry of a subject into a play area through receipt of a subject registration and/or admittance signal transmitted from a system server. In at least one embodiment, the system can detect entry of a subject via an RFID location interaction (e.g., as described herein). In some embodiments, the system may await receipt of a subject exit signal (e.g., from a server) before proceeding to steps 706-712. A subject exit signal may be generated by the system following a subject checkout process and/or following detection of a particular RFID location interaction (e.g., for example, location interaction associated with a subject returning their RFID wristband to a particular room of a play area). Thus, the system may proceed to specific steps of a behavior tracking and recommendation process based on whether or not a subject has entered a play area and whether or not the subject has exited the play area.

In various embodiments, the system may generate one or more aggregated metrics sourced from historical and other aggregated data. The one or more aggregated metrics can include, but are not limited to, toy rankings that identify one or more most popular toys (e.g., out of toys dispersed throughout a play area, or section thereof, or toys purchased on a website), room rankings that identify one or more most popular sections of a play area, experience rankings that identify one or more most popular experiences provided in a play area, and other rankings (for example, on/off-site activities, resources, events, etc.). Thus, the system can generate one or more aggregated metrics that may be used to further optimize and evaluate a play area, toy offerings, experience offerings, and other matters.

FIG. 8 shows an exemplary machine learning process 800 according to one embodiment. At step 802, the process 800 includes generating a training dataset comprising one or more parameters. The training dataset can be generated based on training data. The training data can include interaction data and known interests associated with one or more subjects. In one example, the training data includes historical interactions of a particular subject with various areas of a play environment and interactions with various toys, experiences, and other subjects therein. The training data can include one or more of, but is not limited to, categorical data, observational data, and digital interaction data. Categorical data can include data indicating whether or not a subject demonstrated a particular behavior or action, such as entering a particular area, playing with a particular toy, etc. The categorical data, or a subset thereof, can be expressed as one or more cognitive development markers. In one example, a subject that played with a musical instrument (e.g., as determined based on tracked RFID interactions) for a predetermined time period (e.g., 5 minutes, 10 minutes, etc.) is assigned a cognitive development marker for creativity and/or musical affinity. Observational data can include data that scales one or more aspects of behavior demonstrated (or not demonstrated) by the subject. For example, observational data can include a numerical value on a scale of 1-10 that represents a level of socialization that the subject demonstrated with other subjects in a particular play area (e.g., 1 representing little or no socialization and 10 representing virtually continuous socialization). The digital interaction data can include tracked engagement of a subject with various digital content, such as electronic communications, offers, animations, games, etc. Any data described herein that is collected by or provided to the system may be included in the training data. The training data may be pseudo-anonymized or fully anonymized and, in some embodiments, may be processed to isolate or reduce a prevalence of potential bias factors, such as age, sex, gender, and etc.

The training data can be selected to comprise data for a particular time period, such as, for example, one day, one month, one year, and etc., or for a predetermined number of visits to the play environment, such as, for example, one visit, five visits, ten visits, and etc. In some embodiments, the training data is selected based on one or more criteria of a subject for which interests are to be predicted. In one example, the subject is a seven-year old male and the training data is sourced from one or more other seven-year old males (or, in some embodiments, the same seven-year old male). In some embodiments, a subset of the information included in the training data can be predetermined based on heuristics and/or manual input by a user.

The training data can be organized into a plurality of parameters. For example, a time series record of tracked interactions in which a subject played with a particular toy can be expressed as a percentage of the subject's total time spent in a play environment. As another example, a subject can be assigned a score from 1-5 that corresponds to a number of play areas within a play environment that the subject visited in which the subject interacted with at least one play element, such as a toy, for a predetermined time period (e.g., a value of 5 indicating that the subject visited 5 play areas and interacted with a toy or experience in each play area). In the same example, the particular play areas in which the subject demonstrated the greatest amount of interaction can be mapped to one or more cognitive development parameters, such as working memory, pattern recognition, etc. Non-limiting examples of scaled and categorical values for cognitive development markers and other data are included in Table 1. As shown, a subset of interaction data can be scale-based and a second subset can be categorical, for example the second subset can be Boolean-value based (e.g., in which a value of 1 corresponds to YES and a value of 0 corresponds to NO).

TABLE 1
Exemplary Interaction Data

| Development | | Loca- | Loca- | Loca- | Loca- | Loca- |
|---|---|---|---|---|---|---|
| Category | Sub-category | tion 1 | tion 2 | tion 3 | tion 4 | tion 5 |
| Cognitive | Sustained | 8 | 7 | 1 | 10 | 8 |
| Development | Attention Span | | | | | |
| Cognitive | Questioning | 4 | 9 | 5 | 2 | 0 |
| Development | Skills | | | | | |
| Cognitive | Working | 4 | 9 | 9 | 5 | 3 |
| Development | Memory | | | | | |
| Cognitive | Pattern | 10 | 3 | 0 | 10 | 9 |
| Development | Recognition | | | | | |
| Cognitive | Category | N/A | YES | NO | NO | YES |
| Development | Formation | | | | | |
| Cognitive | Problem | 6 | 0 | 5 | 1 | 10 |
| Development | Solving | | | | | |
| Cognitive | Creativity and | 9 | 9 | 1 | 4 | 8 |
| Development | Imagination | | | | | |
| Physical | Fine Motor | 10 | 10 | 6 | N/A | 9 |
| Development | Skills | | | | | |
| Physical | Gross Motor | 2 | 0 | 8 | 2 | 8 |
| Development | Skills | | | | | |
| Physical | Sensory | 0 | 5 | 2 | 2 | 10 |
| Development | Processing | | | | | |
| Social | Self- | YES | NO | YES | YES | YES |
| Emotional | Awareness | | | | | |
| Development | | | | | | |
| Social | Self- | 2 | 4 | 4 | 4 | 4 |
| Emotional | Management | | | | | |
| Development | | | | | | |
| Social | Social | 1 | 8 | 8 | 5 | 5 |
| Emotional | Awareness | | | | | |
| Development | | | | | | |
| Social | Decision | 0 | 5 | 2 | 7 | 10 |
| Emotional | Making | | | | | |
| Development | | | | | | |
| Social | Reflectiveness | 10 | 0 | 1 | 1 | 0 |
| Emotional | | | | | | |
| Development | | | | | | |
| Social | Curiosity | 0 | 10 | 2 | 10 | 2 |
| Emotional | | | | | | |
| Development | | | | | | |
| Social | Relationship | 3 | 8 | 6 | 3 | 1 |
| Emotional | Skills | | | | | |
| Development | | | | | | |
| Language | Speaking and | 7 | 0 | 2 | 1 | 0 |
| Development | Listening Skills | | | | | |
| Language | Reading and | 9 | 4 | 5 | 3 | 3 |
| Development | Writing | | | | | |
| | Foundations | | | | | |

Each location of a play environment can be associated with specific play types that may be used to predict a subject's interests. Non-limiting examples of play types include, but are not limited to, creation (e.g., expressing one's self through creative activities), imagination (e.g., engaging in stories and environments through role or narrative play), achievement (e.g., goal-oriented activities activated by collaboration or competition), exploration (e.g., learning and discovery of the surrounding environment), and construction (e.g., combining existing elements to create a new element). In at least one embodiment, play types can be associated with various categories of development including, but not limited to, emotional (e.g., processing and managing emotional responses in various situations), social (e.g., navigating positive and negative interactions with others), physical (e.g., coordination and agility using fine and gross motor skills), cognitive (e.g., formation and understanding of concepts and systems), and language (e.g., communication of feelings and ideas through writing and speech).

In various embodiments, each area, activity, toy, interaction and/or experience of a play environment and/or an external environment (e.g., including digital and physical environments) is assigned a floating point value in each category. The floating point values for the categories can be used to cluster similar areas, activities, toys, and etc. for the purposes of generating recommendations based on past behavior of a subject, as well as behavior from similar subjects. Data associated with subjects can be used to identify patterns of interests and subject behaviors. The data associated with subjects can include, for example, age, normal attendance (e.g., frequency of visit to a play environment or play area), attendance at special events and programs, survey responses (e.g., self-reported interests, behavior, feedback on previous predicted interests, recommendations, etc.), purchase history, interaction data (e.g., such as tracked RFID interactions), and recorded observations, for example, from staff members in a play environment.

The training dataset can be automatically generated based on data from subjects that positively responded to previous recommendations provided thereto and which were generated based on predictions of subject interests. In some embodiments, one or more elements of the training dataset can be included based on input from a subject matter expert or other user. A plurality of training datasets can be generated, for example, that correspond to various types of subjects. For example, a training dataset can be generated for a particular age band, cognitive development level, or pattern of behavior. At step 804, the process 800 includes determining weight values for each parameter of the training dataset. Determining the weight values can include, for example, performing a regression analysis on the training dataset and known interests to compute a predictive power of each of the plurality of parameters of the training dataset. In some embodiments, local topic modeling and clustering processes are performed to identify parameters that are predictive for particular interests. For example, based on clustering techniques, categorical data associated with a music room (e.g., number of visits, duration of visits, interaction with an instrument, etc.) and particular observational data (e.g., asking questions about an instrument, playing scales, etc.) are determined to be predictive for musical interest. Parameters demonstrating greater predictive power can correspond to greater weight values being determined (e.g., as compared to those demonstrated by less predictive parameters). In some embodiments, one or more weight values can be predetermined based on heuristics and/or manual input by a user. In at least one embodiment, a weight for a categorical parameter can be generated based on an observational score attributed to the categorical parameter. For example, for a categorical parameter for playing with a toy, a weight value can be computed based on an observation score quantifying a level of creativity demonstrated by a subject that interacted with the toy.

At step 806, the process 800 includes assigning a parameter weight to each parameter of the training dataset and generating a machine learning model based on the weighted parameters (e.g., the parameter weight being based on the corresponding weight value determined at step 804). Assigning the parameter weight can include scaling and/or multiplying the floating point or other value of each parameter by the weight value, the weight value at least partially determining the contribution of each parameter to a prediction generated by a machine learning model. The machine learning model can include, for example, a neural network, such as a perceptron trained to classify a subject into one of a plurality of play profiles based on the subject's tracked behavior, wherein the play profile corresponds to one or more particular interests and is associated with particular toys, experiences, and activities that may be recommended to the subject.

In some embodiments, the machine learning model is a supervised learning model in which the training dataset for training the model includes labels for known outputs (e.g., predetermined interests for each subject in the training dataset). In at least one embodiment, the machine learning model is an unsupervised learning model in which the training dataset may exclude labels indicating an expected or correct output.

At step 808, the process 800 includes generating, using the training dataset, an output from the machine learning model and analyzing the output. The output can include, for example, one or more predicted interests. Analyzing the output can include, for example, computing an accuracy metric between the one or more predicted interests and one or more known interests that correspond to each suspect. Accuracy can be computed based on calculating a similarity or dissimilarity score between a predicted and a known interest. In one example, a known interest is an interest in horses and a corresponding accuracy metric for a predicted interest in animals is greater than an accuracy metric for a predicted interest in sports (e.g., which may be less related to the known interest).

At step 810, the process 800 includes determining that the output from the machine learning model satisfies one or more thresholds. The threshold can be, for example, an accuracy level between the predicted interests and the known interests of the training dataset. In response to determining that the output satisfies the threshold, the process 800 can proceed to step 812. In response to determining that the output does not satisfy the threshold, the process 800 can return to step 804 or 806 in which parameter values and other properties of the machine learning model can be optimized. In one or more embodiments, the process 800 may perform a validation technique, such as K-folds cross-validation to train the machine learning model using a plurality of training datasets to improve the performance of the model.

At step 812, the process 800 includes predicting one or more interests using the trained machine learning model. Interaction data for a particular subject can be provided as an input to the trained machine learning model and the model can be executed to generate output comprising one or more predicted interests based on the input. The predicted interests can be scored, for example, based on an estimated level of interest. In some embodiments, a second machine learning model can be trained to generate recommendations based on the predicted interests. In at least one embodiment, recommendations corresponding to potential predicted interests may be predefined and maintained in a database, and may be retrieved based on the output of the model.

The output can include a ranking of the parameters that contributed the most to the predicted interest. In one example, an output can include a predicted interest in outdoor animal-based activities and can further include a ranking of parameters including play with a particular animal toy, level of participation in and attendance at animal-related programming, and scaled metrics for creation, imagination, and exploration demonstrated by the corresponding subject in an animal-related play area or activity. The output, input, and model version can be stored in a database and can be associated with the subject to enable analysis and optimization, for example, in response to determining that the predicted interests for the subject were not accurate or that the subject did not engage with recommendations provided thereto based on the predicted interests.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media, which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid-state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general-purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a general-purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein.

What is claimed is:

1. A process for training a computer-implemented model, comprising:
collecting, via at least one computing device, training data associated with at least one entity, wherein the training data comprises categorical data, observational data, and at least one known interest;
generating, via the at least one computing device, a training dataset based on the categorical data, wherein the training dataset comprises the known interest and a plurality of parameters based on the categorical data;
determining, via the at least one computing device, a respective weight value for each of the plurality of parameters based on the observational data;
generating, via the at least one computing device, a respective weight for each of the plurality of parameters based on the respective weight value corresponding to each of the plurality of parameters; and
training, via the at least one computing device, a machine learning model using the training dataset.

2. The process of claim 1, wherein the categorical data comprises cognitive development markers.

3. The process of claim 1, wherein a first subset of the training data is collected from a physical environment and a second subset of the training data is collected from a digital environment, wherein the digital environment comprises an electronic communication.

4. The process of claim 1, further comprising executing, via the at least one computing device, the machine learning model to generate an output comprising an interest associated with an additional entity.

5. The process of claim 4, further comprising:
generating, via the at least one computing device, an alert comprising the output, a networking address associated with the output, and an activity associated with the interest; and
causing, via the at least one computing device, the alert to be rendered on at least one computing device associated with the additional entity.

6. The process of claim 4, further comprising:
collecting, via the at least one computing device, secondary data associated with the additional entity, the secondary data comprising secondary categorical data and secondary observational data;
adjusting, via the at least one computing device, each of the plurality of parameters based on the secondary categorical data; and
adjusting, via the at least one computing device, the respective weight value of each the plurality of parameters based on the secondary observational data.

7. The process of claim 1, wherein the machine learning model is a neural network.

8. A system for training a computer-implemented model, comprising:
a data store configured to store training data comprising categorical data, observational data, and at least one known interest;
at least one computing device in communication with the data store, the at least one computing device being configured to:
collect training data associated with at least one entity;
generate a training dataset based on the categorical data, the training dataset comprising the known interest and a plurality of parameters based on the categorical data;
determine a respective weight value for each of the plurality of parameters based on the observational data;
generate a respective weight for each of the plurality of parameters based on the respective weight value corresponding to each of the plurality of parameters; and
train a machine learning model using the training dataset.

9. The system of claim 8, wherein the categorical data comprises cognitive development markers.

10. The system of claim 8, wherein a first subset of the training data is collected from a physical environment and a second subset of the training data is collected from a digital environment, wherein the digital environment comprises an electronic communication.

11. The system of claim 8, wherein the at least one computing device is further configured to execute the machine learning model to generate an output comprising an interest associated with an additional entity.

12. The system of claim 11, wherein the at least one computing device is further configured to:
generate an alert comprising the output, a networking address associated with the output, and an activity associated with the interest; and
cause the alert to be rendered on a computing device associated with the entity.

13. The system of claim 11, wherein the at least one computing device is further configured to:
collect secondary data associated with the additional entity, the secondary data comprising secondary categorical data and secondary observational data;
adjust each of the plurality of parameters based on the secondary categorical data; and
adjust the respective weight value of each the plurality of parameters based on the secondary observational data.

14. The system of claim 8, wherein the training data further comprises digital interaction data and a subset of the training dataset is based on the digital interaction data.

15. A non-transitory computer-readable medium for training a computer-implemented model having stored thereon computer program code that, when executed on at least one computing device, causes the at least one computing device to:
collect training data associated with at least one entity, the training data comprises categorical data, observational data, and at least one known interest;
generate a training dataset based on the categorical data, the training dataset comprising the known interest and a plurality of parameters based on the categorical data;
determine a respective weight value for each of the plurality of parameters based on the observational data;
generate a respective weight for each of the plurality of parameters based on the respective weight value corresponding to each of the plurality of parameters; and
train a machine learning model using the training dataset.

16. The non-transitory computer-readable medium of claim 15, wherein the categorical data comprises cognitive development markers.

17. The non-transitory computer-readable medium of claim 15, wherein a first subset of the training data is collected from an RFID-based source and a second subset of the training data is collected from a computer vision-based source.

18. The non-transitory computer-readable medium of claim 15, wherein the computer program code further causes the at least one computing device to execute the machine learning model to generate an output comprising:
a most-weighted parameter of the plurality of parameters; and
an interest associated with an additional entity and the most-weighted parameter of the plurality of parameters.

19. The non-transitory computer-readable medium of claim 18, wherein the computer program code further causes the at least one computing device to:
generate an alert comprising the output, a networking address associated with the output, and a location associated with the interest; and
cause the alert to be rendered on a computing device associated with the entity.

20. The non-transitory computer-readable medium of claim 19, wherein the computer program code further causes the at least one computing device to generate a cognitive development summary of the entity based on the plurality of parameters and the output, wherein the alert further comprises the cognitive development summary.
